(19) United States
(12) Patent Application Publication
(10) Pub. No.: US 2011/0199402 A1
(43) Pub. Date: Aug. 18, 2011

(54) IMAGE DISPLAY SYSTEMS, IMAGE DISPLAY DEVICES, AND OPTICAL SHUTTERS

(75) Inventors: Junichirou Ishii, Tokyo (JP); Masao Imai, Tokyo (JP); Fujio Okumura, Tokyo (JP)

(73) Assignee: NEC CORPORATION, Tokyo (JP)

(21) Appl. No.: 13/124,218

(22) PCT Filed: Sep. 29, 2009
(86) PCT No.: PCT/JP2009/066939

§ 371 Date: Apr. 14, 2011

(30) Foreign Application Priority Data
Oct. 20, 2008 (JP) 2008-269963

(51) Int. Cl. G09G 3/36; G02F 1/01; G09G 5/10

(52) U.S. Cl. 345/690; 359/238; 345/102

(57) ABSTRACT

An image display system includes display element 13 that displays at least two display states at different timings, the two display states being a first display state in which a first image is displayed with a first polarized light and a second image is displayed with a second polarized light whose polarized component is different from that of the first polarized light, the second image serving to cancel the first image, and a second display state in which the second image is displayed with the first polarized light and the first image is displayed with the second polarized light; and optical shutter 14 that transmits the first polarized light and blocks the second polarized light in the first display state and transmits the second polarized light and blocks the first polarized light in the second display state.

### TECHNICAL FIELD

The present invention relates to image display systems, in particulars, image display systems that provide a particular image to a particular user and another image to another user.

### BACKGROUND ART

JP63-312788A (hereinafter referred to Patent Literature 1) describes an image display device that prevents the other from furtively viewing a display image. FIG. 1 shows the structure of the image display device.

Referring to FIG. 1, the image display device is composed of image information storage memory 202, combining circuit 205, chroma/luminance converting circuit 206, image display device 208, eyeglass shutter timing generation circuit 209, and eyeglasses 211.

Image information storage memory 202 stores input image signal 201 frame by frame based on frame signal 203. The image signal stored in image information storage memory 202 is read two times at a speed two times as high as a frame period. The image signal that is read the first time is supplied to combining circuit 205 as ½ compressed first image signal 204. The image signal that is read the second time is converted with respect to chroma and luminance by chroma/luminance converting circuit 206 and supplied as second image signal 207 to combining circuit 205. The output of combining circuit 205 is supplied as a display signal to image display device 208. An image based on first image signal 204 and an image based on second image signal 207 are alternately displayed on image display device 208.

Eyeglass shutter timing generation circuit 209 generates eyeglass shutter drive signal 210 that drives the shutter of eyeglasses 211 based on frame signal 203. Eyeglass shutter drive signal 210 is a timing signal that causes the shutter of eyeglasses 211 (block state) to be turned on while an image based on second image signal 207 is displayed. Since eyeglass shutter drive signal 210 drives the shutter of eyeglasses 211, only an image based on first image signal 204 is provided to a person who wears eyeglasses 211.

On the other hand, a person who does not wear eyeglasses 211 can see a gray image in which an image based on first image signal 204 and an image based on second image signal 207 are fused because of a visual temporal integration effect (afterimage). This gray image is an image that is completely different from the image based on first image signal 204. Thus, a person who does not wear eyeglasses 211 cannot distinguish an image based on first image signal 204.

U.S. Pat. No. 5,537,476 specification (hereinafter referred to as Patent Literature 2) discloses another image display device. FIG. 2 shows the structure of the image display device.

Referring to FIG. 2, the image display device includes three-primary color displays 301, 302 that have different primary color spectra from each other, beam splitter 303 that combines first and second image lights that pass through these three-primary color displays 301, 302, and filter 304 that includes a characteristic that allows only the first or second image light of the combined image light that passes through beam splitter 303 to be transmitted. If the combined image light that passes through beam splitter 303 is viewed through filter 304, only the first or second image light is viewed. If filter 304 is not used, the combined image is viewed and thereby the first or second image light cannot be distinguished.

### DISCLOSER OF THE INVENTION

However, the image display devices described in Patent Literatures 1 and 2 have the following problems.

In the image display device described in Patent Literature 1, since the first image based on the first image signal and the second image based on the second image signal have the relationship of positive and negative, a bright area on the first image becomes a dark area on the second image, whereas a dark area on the first image becomes a bright area on the second image. Thus, since the difference of luminances of corresponding areas between the first image and the second image is large, when the first image and the second image are alternately displayed, the bright portion and the dark portion are alternately displayed. Thus, if a person who does not wear eyeglasses sees a gray image in which the first image and the second image are fused, the difference of luminances of the first image and the second image may be sensed as flicker.

If the first image is an image that includes a boundary (edge) in which a high luminance area and a low luminance area spatially and sharply change and if the boundary (edge) is a moving image that temporally moves, when the moving image is displayed with the first image signal and the second image signal, a person who does not wear eyeglasses senses a high contrast area and a sharply edged area (an area including many high frequency components) as a false contour.

In the following, a false contour will be specifically described.

FIG. 3 is a schematic diagram showing an example of a moving image displayed with the first and second image signals. FIG. 4 is a schematic diagram showing a state in which images of particular lines of the moving image are arranged in the order in which they are displayed, namely, in time series.

In FIG. 3, an exemplary image on the left represents a moving image based on the first image signal, whereas an exemplary image on the right represents a moving image based on the second image signal. In the moving image based on the first image signal, black stripe 100a that vertically extends moves from left to right on white area 100b. In the moving image based on the second image signal, white stripe 101a that vertically extends moves from left to right on black area 101b. The moving image based on the second image signal is a reversed image of the moving image based on the first image signal and when these moving images are alternately observed, a gray moving image is observed as a sensed image.

However, if the above-described gray moving image is observed, the view point of the observer moves along the boundary of black stripe 100a and white area 100b and the boundary of white stripe 101a and black area 101b. As a result, the boundary of the left end of black stripe 100a and white area 100b in the image based on the first image signal and the boundary of the left end of white stripe 101a and black area 101b in the image based on the second image signal are sensed as a white false contour in the gray moving image. Likewise, the boundary of the right end of black stripe 100a and white area 100b in the image based on the first image signal and the boundary of the right end of white stripe 101a and black area 101b in the image based on the second image signal are sensed as a black false contour on a gray moving image. In other words, since a person who does not wear eyeglasses can see the contour of the first image that only a person who wears eyeglasses can see, the secrecy will deteriorate. Since the image display device described in Patent Literature 2 simply combines image lights that pass through two three-primary color displays and that displays the resultant image unlike the structure in which images having the relationship of positive and negative are switched at high speed as described in Patent Literature 1, the above-described flicker does not occur. However, a filter that blocks one of the image lights that pass through the two three-primary color displays can be easily forged using a material such as cellophane. Thus a case may occur in which, through the use of a forged filter, a display image secretly glance at.

An object of the present invention is to provide image display systems, image display devices, and optical shutters that can solve problems of flicker, deterioration of secrecy due to sense false contours, and display images being secretly glanced at through the use of a forged optical shutter (filter).

To accomplish the above-described object, an image display system according to the present invention includes display means that displays at least two display states at different timings, the two display states being a first display state in which a first image is displayed with a first polarized light and a second image is displayed with a second polarized light whose polarized component is different from that of the first polarized light, the second image serving to cancel the first image, and a second display state in which the second image is displayed with the first polarized light and the first image is displayed with the second polarized light; and

an optical shutter that transmits the first polarized light and blocks the second polarized light in the first display state and transmits the second polarized light and blocks the first polarized light in the second display state.

An image display device according to the present invention includes display means that displays at least two display states at different timings, the two display states being a first display state in which a first image is displayed with a first polarized light and a second image is displayed with a second polarized light whose polarized component is different from that of the first polarized light, the second image serving to cancel the first image, and a second display state in which the second image is displayed with the first polarized light and the first image is displayed with the second polarized light; and

display control means that controls switching between the first display sate and the second display state and outputs a synchronization signal that represents switching timings between the first and second display states.

An optical shutter according to the present invention is

an optical shutter that serves to observe a display image on an image display device that is capable of switching between two display states of a first display state in which a first image is displayed with a first polarized light and a second image is displayed with a second polarized light whose polarized component is different from that of the first polarized light, the second image serving to cancel the first image, including:

a liquid crystal panel unit that switches between a first polarization separation state in which the first polarized light is transmitted and the second polarized light is blocked and a second polarization separation state in which the second polarized light is transmitted and the first polarized light is blocked; and

a liquid crystal drive section that causes, based on a synchronization signal that is supplied from the image display device and that represents switching timings between the first and second display, the liquid crystal panel unit to operate in the first polarization separation state when the synchronization signal states represents the first display state, and to operate in the second polarization separation state when the synchronization signal represents the second display state.

Another optical shutter according to the present invention is

an optical shutter that serves to observe a display image on an image display device that is capable of switching among three display states of a first display state in which a first image is displayed with a first polarized light and a second image is displayed with a second polarized light whose polarized component is different from that of the first polarized light, the second image serving to cancel the first image, a second display state in which the second image is displayed with the first polarized light and the first image is displayed with the second polarized light, and a third display state in which a third image is displayed with the first and second polarized lights, the third image being different from the first image, including:

a liquid crystal panel unit that switches among a first polarization separation state in which the first polarized light is transmitted and the second polarized light is blocked, a second polarization separation state in which the second polarized light is transmitted and the first polarized light is blocked, and a third polarization separation state in which both the first and second polarized lights are blocked; and

a liquid crystal drive section that causes, based on a synchronization signal that is supplied from the image display device and that represents switching timings between the first and second display, the liquid crystal panel unit to operate in the first polarization separation state when the synchronization signal states represents the first display state, to operate in the second polarization separation state when the synchronization signal represents the second display state, and to operate in the third polarization separation state when the synchronization signal represents the third display state.

### BRIEF DESCRIPTION OF DRAWINGS

FIG. 1 is a block diagram showing the structure of an image display device described in Patent Literature 1.

FIG. 2 is a block diagram showing the structure of an image display device described in Patent Literature 2.

FIG. 3 is a schematic diagram showing an exemplary moving image in the image display device described in Patent Literature 1.

FIG. 4 is a schematic diagram showing a state in which images on particular lines of the moving image shown in FIG. 3 are arranged in the order in which they are displayed, namely, in time series.

FIG. 5 is a block diagram showing the structure of an image display system according to a first exemplary embodiment of the present invention.

FIG. 6 is a schematic diagram that describes the theory of operation of the image display system shown in FIG. 5.

FIG. 7 is a characteristic diagram showing the relationship among critical fusion frequency, contrast ratio, and average luminance in the case in which a bright image and a dark image are alternately displayed.

FIG. 8 is a block diagram showing a first exemplary structure of a display means that comprises the image display system shown in FIG. 5.

FIG. 9 is a block diagram showing a second exemplary structure of the display means that comprises the image display system shown in FIG. 5.

FIG. 10 is a block diagram showing a third exemplary structure of the display means that comprises the image display system shown in FIG. 5.

FIG. 11A is a plan view of a color filter of a liquid crystal panel unit that comprises the display means shown in FIG. 10.

FIG. 11B is a plan view of a polarizing filter of the liquid crystal panel unit that comprises the display means shown in FIG. 10.

FIG. 11C is a plan view showing another polarizing filter of the liquid crystal panel unit that comprises the display means shown in FIG. 10.

FIG. 11D is a schematic diagram that describes the relationship of each polarizing filter and each pixel (each line) of a liquid crystal section that comprise the liquid crystal panel unit shown in FIG. 11.

FIG. 12A is a schematic diagram showing an exemplary polarizing filter in which P polarizing filters and S polarizing filters are arranged in a zigzag shape.

FIG. 12B is a schematic diagram showing another exemplary polarizing filter in which P polarizing filters and S polarizing filters are arranged in a zigzag shape.

FIG. 13 is a block diagram showing an exemplary structure of an optical shutter that comprises the image display system shown in FIG. 5.

FIG. 14 is a schematic diagram showing an exemplary moving image displayed on the display means of the image display system shown in FIG. 5.

FIG. 15A is a schematic diagram showing a state in which images on particular lines are arranged in the order in which they are displayed, namely in time series, in the case in which the moving image shown in FIG. 14 is a moving image with a P polarized light.

FIG. 15B is a schematic diagram showing a state in which images of particular lines are arranged in the order in which they are displayed, namely, in time series, in the case in which the moving image shown in FIG. 14 is a moving image with an S polarized light.

FIG. 16 is a schematic diagram that describes another theory of operation of the image display system shown in FIG. 5.

FIG. 17 is a block diagram showing the structure of an image display system according to a second exemplary embodiment of the present invention.

FIG. 18 is a schematic diagram that describes the theory of operation of the image display system shown in FIG. 17.

FIG. 19 is a block diagram showing a first exemplary structure of an optical shutter that comprises the image display system shown in FIG. 17.

FIG. 20A is a schematic diagram showing an example of a first polarization separation state of the optical shutter shown in FIG. 19.

FIG. 20B is a schematic diagram showing an example of a second polarization separation state of the optical shutter shown in FIG. 19.

FIG. 20C is a schematic diagram showing another example of the second polarization separation state of the optical shutter shown in FIG. 19.

FIG. 21 is a schematic diagram showing a second exemplary structure of the optical shutter that comprises the image display system shown in FIG. 17.

FIG. 22 is a block diagram showing a drive section and an electrode section of a liquid crystal panel in the optical shutter shown in FIG. 21.

FIG. 23 is a schematic diagram that describes the theory of operation of an image display system according to a third exemplary embodiment of the present invention.

FIG. 24A is a schematic diagram showing an example of a display means using a ¼ wavelength plate that comprises an image display system according to another exemplary embodiment of the present invention.

FIG. 24B is a block diagram showing an example of an optical shutter using a ¼ wavelength plate that comprises an image display system according to another exemplary embodiment of the present invention.

FIG. 25A is a schematic diagram showing a first polarization separation state of the optical shutter shown in FIG. 24B.

FIG. 25B is a schematic diagram showing a second polarization separation state of the optical shutter shown in FIG. 24B.

FIG. 26 is a schematic diagram showing another example of a display means using a ¼ wavelength plate that comprises an image display system according to another exemplary embodiment of the present invention.

FIG. 27 is a schematic diagram showing another example of a display means using a ¼ wavelength plate that comprises an image display system according to another exemplary embodiment of the present invention.

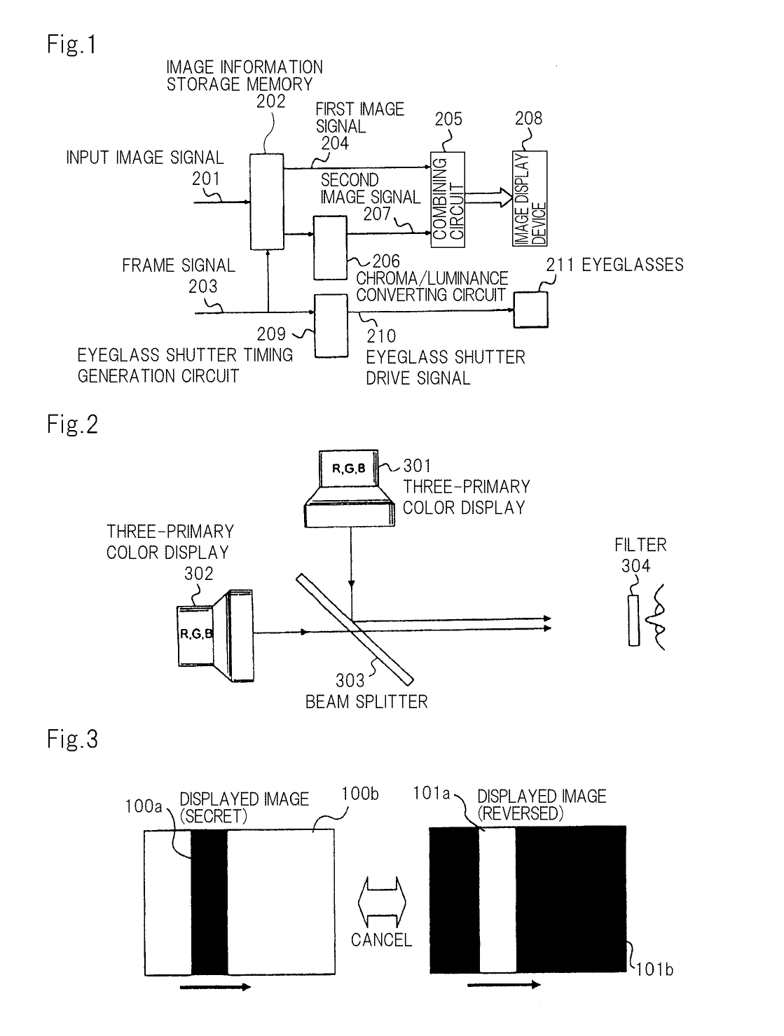

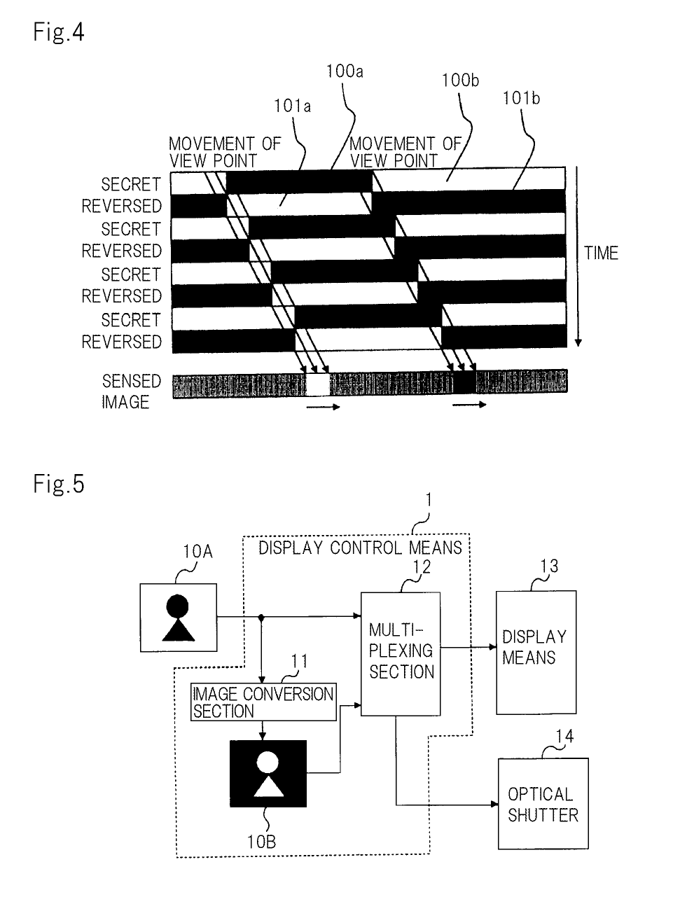

### DESCRIPTION OF REFERENCE NUMERALS

1 Display control means
11 Image conversion section
12 Multiplexing section
13 Display means
14 Optical shutter

### BEST MODE FOR CARRYING OUT THE INVENTION

Next, with reference to drawings, an exemplary embodiment of the present invention will be described.

### First Exemplary Embodiment

FIG. 5 is a block diagram showing the structure of an image display system according to a first exemplary embodiment of the present invention.

As shown in FIG. 5, the image display system according to this exemplary embodiment includes display means 13, display control means 1 that controls a display operation of display means 13 for an image, and optical shutter 14 that serves to observe an image (still image or moving image) displayed on display means 13.

Display means 13 displays at different timings at least two display states of a first display state in which a first image (Q) is displayed with a first polarized light and in which a second image (I) that cancels the first image is displayed with a second polarized light whose polarized component is different from that of the first polarized light and a second display state in which the second image (I) is displayed with the first polarized light and the first image (Q) is displayed with the second polarized light.

Optical shutter 14 is structured such that it transmits the first polarized light and blocks the second polarized light in the first display state and such that it transmits the second polarized light and blocks the first polarized light in the second display state.

Display control means 1 controls switching between the first display state and the second display state on display means 13. As a specific exemplary circuit that performs the switching control, display control means 1 includes image conversion section 11 and multiplexing section 12. However, it should be noted that display control means 1 is not limited to the circuit composed of image conversion section 11 and multiplexing section 12, rather display control means 1 may be composed of another circuit as long as switching between the first and second display states can be controlled.

In the example shown in FIG. 5, image signal 10A is supplied to display control means 1. Image signal 10A is an image signal that is supplied frame by frame for example from an external image processing device (such as a personal computer) or an image processing circuit provided in the system to each of image conversion section 11 and multiplexing section 12. In this example, the first image (Q) based on image signal 10A is used as a secret image.

Image conversion section 11 converts the first image (Q) based on inputted image signal 10A into the second image (I) that cancels the first image. In this example, the second image (I) that cancels the first image (Q) is an image in which a fused image of Q and I because of a visual temporal or spatial integration effect becomes an image that is not correlated with Q if the first image (Q) and the second image (I) are alternately or simultaneously displayed. More specifically, image conversion section 11 generates I such that when luminance values of corresponding pixels of Q and I are added, the added value becomes a constant luminance value (for example, gray as an intermediate value in every pixel). Image signal 10B that represents the second image (I) and that is outputted from image conversion section 11 is supplied to multiplexing section 12.

Multiplexing section 12 temporally or spatially multiplexes the first image (Q) based on inputted image signal 10A and the second image (I) based on inputted image signal 10B and generates a QI multiplexed image. A QI multiplexed image signal that is outputted from multiplexing section 12 is supplied to display means 13. In addition, multiplexing section 12 generates a synchronization signal that represents a switching timing of Q and I in the QI multiplexed image signal. The synchronization signal that is outputted from multiplexing section 12 is supplied to optical shutter 14.

Display means 13 displays an image with a first polarized light and an image with a second polarized light based on the QI multiplexed image signal supplied from multiplexing section 12. Generally, a polarized light represents a light in which the direction, in which the electric field changes (the direction in which an electric vector of a light oscillates), deviates. In this example, for convenience, the first polarized light is referred to as the P polarized light, whereas the second polarized light is referred to as the S polarized light. Of course, it may be possible that the first polarized light is referred to as the S polarized light, whereas the second polarized light is referred to as the P polarized light. In this case, the operation can be described such that the S polarized light is substituted for the P polarized light, whereas the P polarized light is substituted for the S polarized light.

Display means 13 performs switching between the first display state in which the first image (Q) is displayed with the P polarized light and in which the second image (I) is displayed with the S polarized light and the second display state in which the second image (I) is displayed with the P polarized light and the first image (Q) is displayed with the S polarized light. Switching between the first and second display states synchronizes with the synchronization signal that is outputted from multiplexing section 12.

Optical shutter 14 is an optical shutter that can perform switching between a first polarization separation state in which the P polarized component is transmitted and in which the S polarized component is blocked and a second polarization separation state in which the S polarized component is transmitted and the P polarized component is blocked. The shape of the optical shutter may be an eyeglass type, a card type, a screen type, a window type, or the like. Switching between the first polarization separation state and the second polarization separation state is performed based on the synchronization signal that is outputted from multiplexing section 12. Specifically, if display means 13 operates in the first display state, optical shutter 14 operates in the first polarization separation state; if display means 13 operates in the second display state, optical shutter 14 operates in the second polarization separation state.

Next, the operation of the image display system according to this exemplary embodiment will be described.

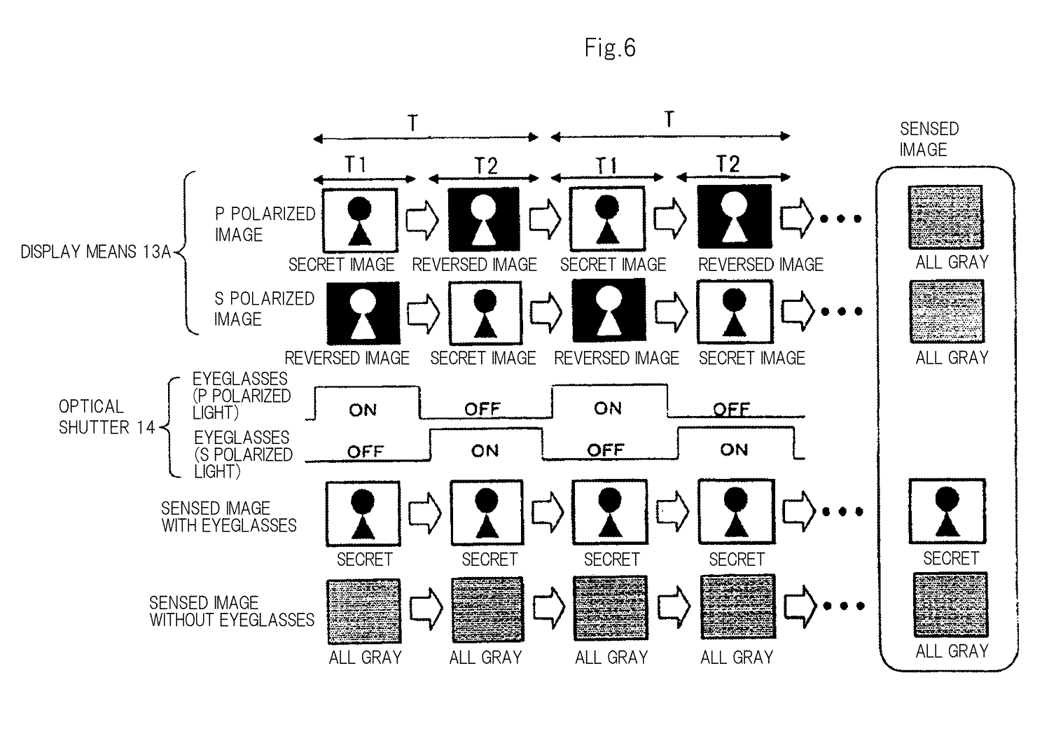

FIG. 6 is a schematic diagram that describes the theory of operation of the image display system shown in FIG. 5. Referring to FIG. 6, in display period T, switching is performed between first display state T1 and second display state T2.

In first display state T1, display means 13 displays a secret image (Q) with the P polarized light and a reversed image (I) with the S polarized light. In this example, the reversed image (I) is an image obtained in such a manner that a reversing process is performed for the luminance value of each pixel that comprises the secret image (Q) based on a predetermined characteristic. For example, the relationship between the secret image (Q) and the reversed image (I) corresponds to the relationship between the negative and positive images of photos.

Moreover, in first display state T1, optical shutter 14 transmits the P polarized component and blocks the S polarized component. In this case, of the secret image (Q) of the P polarized light and the reversed image (I) of the S polarized light that are displayed on display means 13, only the secret image (Q) of the P polarized light is transmitted through optical shutter 14. Thus, in first display state T1, if optical shutter 14 is used, the secret image (Q) becomes a sensed image (a sensed image with eyeglasses shown in FIG. 6). In contrast, if optical shutter 14 is not used, since a spatially combined image of the secret image (Q) of the P polarized light and the reversed image (I) of the S polarized light is displayed on display means 13 and observed, a gray image becomes a sensed image (a sensed image without eyeglasses shown in FIG. 6).

In second display state T2, display means 13 displays the reversed image (I) with the P polarized light and the secret image (Q) with the S polarized light. Moreover, in second display state T2, optical shutter 14 transmits the S polarized component and blocks the P polarized component. In this case, of the reversed image (I) of the P polarized light and the secret image (Q) of the S polarized light that are displayed on display means 13, only the secret image (Q) of the S polarized light is transmitted through optical shutter 14. Thus, in second display state T2, if optical shutter 14 is used, the secret image (Q) becomes a sensed image (a sensed image with eyeglasses shown in FIG. 6). If optical shutter 14 is not used, like the case in above-described first display state T1, a gray image becomes a sensed image (a sensed image without eyeglasses shown in FIG. 6).

Display period T is a period at which switching is performed at equal to or greater than a critical fusion frequency defined by the average luminance and contrast ratio of the secret image (Q) and the reversed image (I). In the following, the critical fusion frequency will be described.

In general, when a bright image and a dark image are alternately displayed, an image obtained by fusing the images is sensed by human eyes at a frequency equal to or lower than a certain frequency (“Optical Engineering Handbook”, pp 149 to 150, Asakura Shoten). This frequency is referred to as critical fusion frequency. In a display standard for television, a display frequency is specified on the basis of this critical fusion frequency. For example, a display period of NTSC is 60 Hz and a display period of PAL is 50 Hz.

The critical fusion frequency depends on a contrast ratio and average luminance of alternately-displayed two images. When a luminance value of a bright image and a luminance value of a dark image of the alternately-displayed two images are respectively represented as I1 and I2, a contrast ratio C and average luminance I_{AV} of these images are respectively given by the following expressions.

C=(I1−I2)/(I1+I2)

I_{AV}=(I1+I2)/2 [Expression 1]

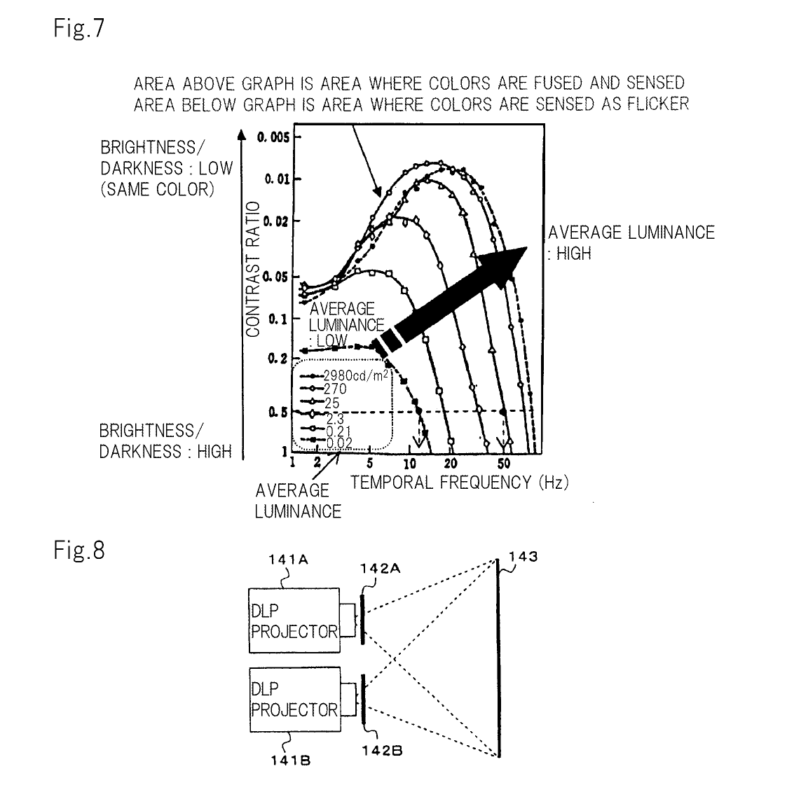

FIG. 7 is a characteristic diagram showing the relationship among critical fusion frequency, contrast ratio, and average luminance in the case in which a bright image and a dark image are alternately displayed. The vertical axis represents the contrast ratio, whereas the horizontal axis represents a time frequency (Hz).

As shown in FIG. 7, the critical fusion frequency is different depending on the contrast ratio of the two images and the average luminance in the entire images. For example, when the contrast ratio C is 0.5 (when a luminance ratio of the bright image and the dark image is 3:1) and the average luminance I_{AV} is low (I_{AV}=0.21 cd/m²), the two images fuse at a frequency of about 12 Hz. On the other hand, when the average luminance I_{AV} is high (I_{AV}=270 cd/m²), for the two images to fuse, it is necessary to raise the frequency to about 50 Hz.

In the image display system according to this exemplary embodiment, display period T needs to be a period equal to or greater than the critical fusion frequency that depends on the contrast ratio of the secret image (Q) and the reversed image (I) and the average luminance of all of both the images (QI). Specifically, the image display system according to this exemplary embodiment includes a storage section (not shown) that stores characteristic data with respect to a characteristic diagram as shown in FIG. 7. Multiplexing section 12 refers to the characteristic data to obtain the critical fusion frequency in an area (an area in which the difference between brightness and darkness is the largest) in which the contrast ratio between the secret image (Q) and the reversed image (I) is the closest to 1. Thereafter, multiplexing section 12 generates a QI multiplexed image such that switching between the first and second display states is performed on display means 13 in display period T equal to or greater than the obtained critical fusion frequency. Thus, the secret image Q and the reversed image I displayed on display means 13 are always temporally fused.

Thus, when the images are viewed not through optical shutter 14, since a gray image is displayed both in the first and second display states, a gray image in the first display state and a gray image in the second display state are temporally fused and thereby a gray image is sensed. If a display image on display means 13 is viewed through an optical filter that transmits only the P polarized light (S polarized light), the secret image (Q) of the P polarized light (S polarized light) and the reversed image (I) of the P polarized light (S polarized light) are temporally fused and thereby like the case in which the display image is viewed not through optical shutter 14, a gray image is sensed.

When the images is viewed through optical shutter 14, the secret image (Q) of the P polarized light and the secret image (Q) of the S polarized light are temporally fused and thereby the secret image is sensed. Thus, since the secret image (Q) can be viewed only through optical shutter 14, surreptitiously glancing at a secret image can be prevented.

In display period T shown in FIG. 6, switching between first display state T1 and second display state T2 can be performed at any timing. At this point, to prevent viewing of the secret image by a surreptitious glance through the use of an optical filter that transmits only the P polarized light (S polarized light), it is preferred that the temporal integration value of the luminances in first display state T1 and the temporal integration value of the luminances in second display state T2 become the same. Specifically, if the display duration in first display state T1 in display period T is denoted by t, the display duration in second display state T2 is denoted by T−t, the luminance value of one particular pixel of secret image (Q) in T1 is denoted by L (Q1), the luminance value of the corresponding pixel of reversed image (I) is denoted by L (I1), the luminance value of the corresponding pixel of secret image (Q) in T2 is denoted by L (Q2), and the luminance value of the corresponding pixel of reversed image (I) is denoted by L (I2), then L (Q1), L (Q2), L (I1), and L (I2) need to be set up such that

L(Q1):L(Q2)=L(I1):L(I2)=T−t:t [Expression 2]

is satisfied. In other words, if the display duration in T1 is shorter than the display duration in T2, the luminance in T1 needs to be set up such that it becomes brighter than the luminance in T2; if the display duration T1 is longer than the display duration in T2, the luminance in T1 needs to be set up such that the luminance in T1 becomes brighter than the luminance in T2. If the display duration in T1 is equal to the display duration in T2, namely, in the case of t=T−t=T/2, the relationship of L(Q1)=L(Q2), L(I1)=L(I2) needs to be satisfied. Otherwise, since the secret image of the P polarized light (S polarized light) in T1 is not cancelled by the reversed image of the P polarized light (S polarized light) in T2, the secret image is furtively glanced with an optical filter that transmits only the P polarized light or S polarized light.

Alternatively, in display period T, the first display state may be executed n times (where n is any positive integer) and the second display state may be executed m times (where m is any positive integer).

Further alternatively, in display period T, switching between the first and second display states may be performed multiple times. In this case, likewise, to prevent a secret glance through an optical filter that transmits only the P polarized light or the S polarized light, it is preferred to set up the luminances of secret image (Q) and reversed image (I) in T1 and T2 such that the temporal integration value of the luminances in the total duration in which first display state T1 is executed in display period T becomes the same as the temporal integration value of the luminances in the total duration in which second display state T2 is executed in display period T. As a method of how to set up the luminances, they can be obtained from the formula shown in the above-described [Expression 2].

On the other hand, the critical fusion frequency varies depending on the magnitude of the contrast ratio of secret image (Q) and reversed image (I). Specifically, if the contrast ratio is large, the critical fusion frequency becomes high; if the contrast ratio is small, the critical fusion frequency becomes low. Thus, multiplexing section 12 may change display period T depending on the magnitude of the contrast ratio of secret image (Q) and reversed image (I) (or the brightness of both images QI).

Next, a specific structure of display means 13 will be described.

(First Exemplary Structure of Display Means 13)

FIG. 8 is a block diagram showing a first exemplary structure of a display means that composes the image display system shown in FIG. 5.

Referring to FIG. 8, display means is an exemplary embodiment of the display means that can switch between the two states of the first and second display states and is provided with two DLP (Digital light processing) projectors 141A, 141B. DLP is a registered trademark of Texas Instruments Inc.

Polarizing plate 142A that transmits only a P polarized component of incident light is provided on an emitting section of DLP projector 141A. Polarizing plate 142B that transmits only an S polarized component of incident light is provided on an emitting section of DLP projector 141B.

DLP projector 141A receives a first image signal with respect to the P polarized image shown in FIG. 6 as a QI multiplexed signal from multiplexing section 12 shown in FIG. 5 and generates an image light based on the first image signal. The image light that is emitted from DLP projector 141A is projected on screen 143 through polarizing plate 142A. The projected image is an image of the P polarized component.

On the other hand, DLP projector 141B receives a second image signal with respect to the S polarized image shown in FIG. 6 as the QI multiplexed signal from multiplexing section 12 shown in FIG. 5 and generates an image light based on the second image signal. The image light that is emitted from DLP projector 141B is projected on screen 143 through polarizing plate 142B. The projected image is an image of the S polarized component.

Since the image lights that are emitted from DLP projectors 141A, 141B are projected on screen 143 through polarizing plates 142A, 142B, respectively, an image of the P polarized component and an image of the S polarized component are simultaneously displayed on screen 143. As the image of the P polarized component, the P polarized image shown in FIG. 6 is displayed; as the image of the S polarized component, the S polarized image shown in FIG. 6 is displayed. Thus, switching between the first display state and the second display state can be performed.

(Second Exemplary Structure of Display Means 13)

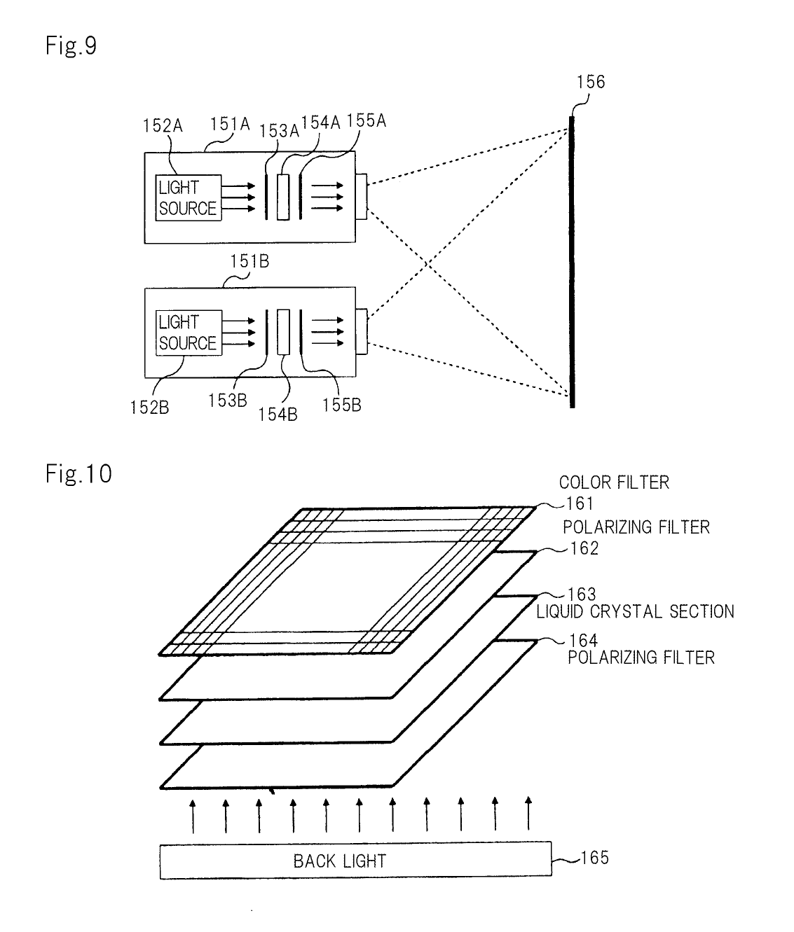

FIG. 9 is a block diagram showing a second exemplary structure of the display means that composes the image display system shown in FIG. 5.

Referring to FIG. 9, the display means is an exemplary embodiment of the display means that can switch between the two states of the first and second display states and is provided with two liquid crystal projectors 151A, 151B.

Liquid crystal projector 151A includes: light source 152A; and S polarizing plate 153A, liquid crystal panel 154A, and P polarizing plate 155A which are arranged in the traveling direction of a light that passes through light source 152A. S polarizing plate 153A transmits only the S polarized component of the light that passes through light source 152A. Liquid crystal panel 154A is illuminated by the light of the S polarized component from S polarizing plate 153A.

Liquid crystal panel 154A is provided with a plurality of pixels and is driven by a drive circuit (not shown). The drive circuit receives the first image signal with respect to the P polarized image shown in FIG. 6 as the QI multiplexed signal from multiplexing section 12 shown in FIG. 5 and drives liquid crystal panel 154A based on the first image signal. A pixel that is turned on transmits a light that passes through S polarizing plate 153A in which the polarized state (S polarized light) is maintained. In contrast, since a pixel that is turned off changes the polarized state of light that passes through S polarizing plate 153A, the light that is transmitted through the pixel contains the P polarized component.

P polarizing plate 155A transmits only the P polarized component of the image light generated by liquid crystal panel 154A. Thus, liquid crystal projector 151A generates the image light of the P polarized component based on the first image signal and projects the image light on screen 156.

Liquid crystal projector 151B includes: light source 152B; and P polarizing plate 153B, liquid crystal panel 154B, and S polarizing plate 155B which are arranged in the traveling direction of a light that passes through light source 152B. P polarizing plate 153B transmits only the P polarized component of the light that passes through light source 152B. Liquid crystal panel 154B is illuminated by the light of the P polarized component that passes through P polarizing plate 153B.

Liquid crystal panel 154B is provided with a plurality of pixels and is driven by a drive circuit (not shown). The drive circuit receives the second image signal with respect to the S polarized image shown in FIG. 6 as the QI multiplexed signal from multiplexing section 12 shown in FIG. 5 and drives liquid crystal panel 154B based on the second image signal. A pixel that is turned on transmits a light that passes through P polarizing plate 153B in which the polarized state (P polarized light) is maintained. In contrast, since a pixel that is turned off changes the polarized state of light that passes through P polarizing plate 153B, the light contains the S polarized component.

S polarizing plate 155B transmits only the S polarized component of the image light generated by liquid crystal panel 154B. Thus, liquid crystal projector 151B generates the image light of the S polarized component based on the second image signal and projects the image light on screen 156.

Thus, since the image light of the P polarized component that passes through liquid crystal projector 151A and the image light of the S polarized component that passes through liquid crystal projector 151B are projected on screen 156, the image of the P polarized component and the image of the S polarized component are simultaneously displayed. As the image of the P polarized component, the P polarized image shown in FIG. 6 is displayed. As the image of the S polarized component, the S polarized image shown in FIG. 6 is displayed. Thus. switching between the first display state and the second display state can be performed.

(Third Exemplary Structure of Display Means 13)

FIG. 10 is a block diagram showing a third exemplary structure of the display means that comprises the image display system shown in FIG. 5.

Referring to FIG. 10, the display means is one embodiment of the display means that can switch between the two states of the first and second display states and is composed of one liquid crystal image display device. The liquid crystal image display device includes a liquid crystal panel unit in which color filter161, polarizing filter 162, liquid crystal section 163 that sandwiches a liquid crystal with transparent electrode members, and polarizing filter 164 are successively layered; and back light 165 that illuminates the liquid crystal panel unit. Alternatively, color filter161 may be arranged between polarizing filter 162 and liquid crystal section 163 or between polarizing filter 164 and liquid crystal section.

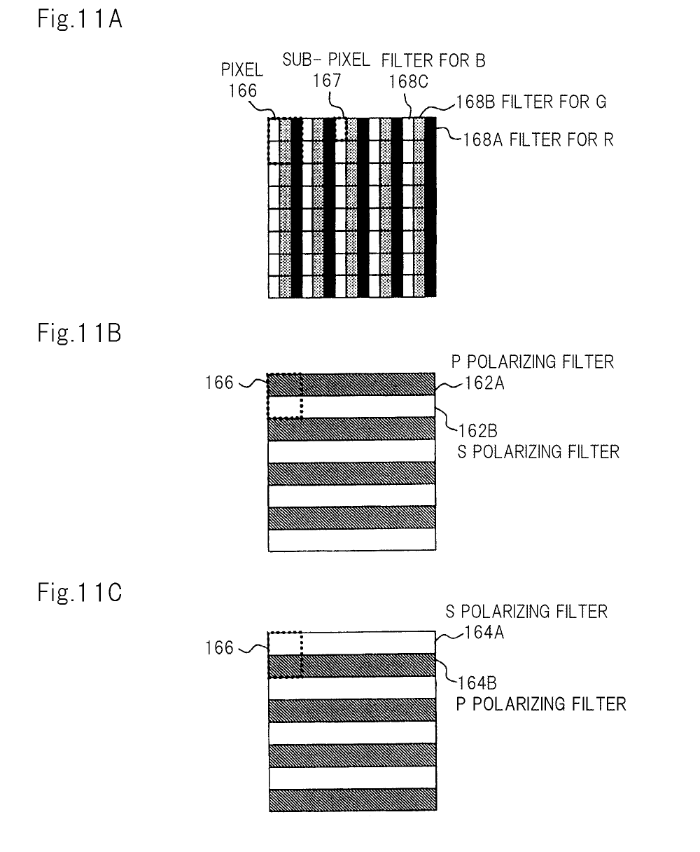

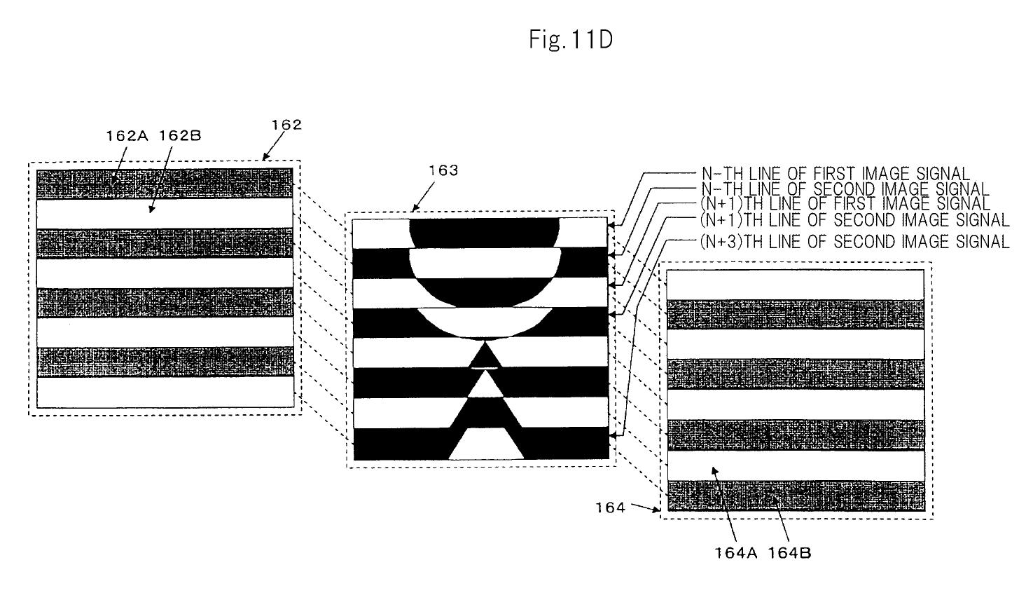

FIG. 11A to FIG. 11C are schematic diagrams that describe the liquid crystal panel unit. FIG. 11A shows a plan view of color filter161. FIG. 11B shows a plan view of polarizing filter 162. FIG. 11C shows a plan view of polarizing filter 164.

Color filter161 is composed of pixels 166, each of which is also composed of six sub pixels that are two-dimensionally arranged. The sub pixels that comprises pixel 166 are arranged in two rows and three columns. As shown in FIG. 11A, among three sub pixels in the first row, filter 168C for B is formed in sub pixel on the left side, filter 168B for G is formed in sub pixel in the center, and filter 168A for R is formed in sub pixel on the right side. In three sub pixels in the second row, filter 168C for B, filter 168B for G, and filter 168A for R are formed in the same arrangement.

In polarization filter 162, as shown in FIG. 11B, linear P-polarization filters 162A and linear S-polarization filters 162B are alternately arranged for each row of sub pixels. In polarization filter 162, only light of the P-polarized light component is transmitted in an area corresponding to sub pixels in the odd number row and only light of the S-polarized light component is transmitted in an area corresponding to sub pixels in the even number row.

In polarization filter 164, as shown in FIG. 7C, linear S-polarization filters 164A and linear P-polarization filter 164B are alternately arranged for each row of sub pixels. In polarization filter 164, only light of the S-polarized light component is transmitted in an area corresponding to sub pixels in the odd number row and only light of the P-polarized light component is transmitted in an area corresponding to sub pixels in the even number row.

Light from backlight 165 is irradiated on the liquid crystal panel unit configured as explained above. Light from backlight 165 is made incident from polarization filter 164 side of the liquid crystal panel unit. In the liquid crystal panel unit, the P-polarized image is formed by sub pixels in the odd number row and the S-polarized image is formed by the sub pixels in the even number row.

The relationship of pixels (lines) of polarizing filter 162, liquid crystal section 163, and polarizing filter 164 in the first display state is as shown in FIG. 11D. In FIG. 11D, an image displayed on liquid crystal section 163 is composed of a part (N-th line to (N+3)th lines) of the secret image (first image) and the reversed image (second image) shown in FIG. 6 and so forth.

As shown in FIG. 11D, the N-th line, the (N+1)-th line, . . . , of the first image are displayed on a liquid crystal section corresponding to lines on which the P polarizing filters of polarizing filter 162 are arranged and corresponding to lines on which the S polarizing filters of polarizing filter 164 are arranged. The N-th line, the (N+1)-th line, . . . , of the second image are displayed on a liquid crystal section corresponding to lines on which the S polarizing filters of polarizing filter 162 are arranged and corresponding to lines on which the P polarizing filters of polarizing filter 164 are arranged. Thus, the first image is emitted as S polarized light; the second image is emitted as P polarized light, and the first image of S polarized light and the second image of P polarized light are alternately displayed line after line.

Since the first and second images are alternately displayed line after line, if the liquid crystal display section is observed with a proper magnification, although a situation in which the first image and the second image are alternately displayed can be confirmed, however, if the liquid crystal display section is observed while keeping a sufficient distance (at a distance where line boundaries cannot be distinguished), since the first image of the S polarized light and the second image of the P polarized light are spatially fused (every line), even if observed without an optical shutter, the content of the first image cannot be viewed.

In the second display state, the order of the first image and the second image shown in FIG. 11D on liquid crystal section 163 is reversed. In other words, the N-th line, the (N+1)-th line, . . . , of the second image are displayed on a liquid crystal section corresponding to lines on which the P polarizing filters of polarizing filter 162 are arranged and corresponding to lines on which the S polarizing filters of polarizing filter 164 are arranged. The N-th line, the (N+1)-th line, . . . , of the first image are displayed on a liquid crystal section corresponding to lines on which the S polarizing filters of polarizing filter 162 are arranged and corresponding to lines on which the P polarizing filters of polarizing filter 164 are arranged. Thus, the first image is emitted as P polarized light, the second image is emitted as S polarized light, and the first image of P polarized light and the second image of S polarized light are alternately displayed line after line.

Specifically, a drive circuit (not shown) receives a first image signal with respect to the P polarized image shown in FIG. 6 as the QI multiplexed signal from multiplexing section 12 shown in FIG. 5 and performs a gradation control for a liquid crystal portion corresponding to sub pixels in the odd number row of liquid crystal section 163 based on the first image signal.

A light with the S polarized component transmitted through S polarizing filters 164A of polarizing filter 164 enters liquid crystal portions corresponding to sub pixels in the odd number row. By varying a voltage applied to liquid crystal portions (sub pixels) based on pixel values (signal values) of sub pixels corresponding to the first image signal, the incident light is modulated and thereby the gradation control is performed. In other words, if the pixel value is white (maximum gradation value), the liquid crystal portion of the corresponding sub pixel is turned on; if the pixel value is black (minimum gradation value), the liquid crystal portion is turned off; and if the pixel value is an intermediate color (between black and white), the liquid crystal portion of the corresponding sub pixel that is caused to be in the intermediate state which is between the on state and the off state.

In the liquid crystal portion (sub pixel) that is turned on, since light that entered from polarizing filter 164 remains in the polarized state (S polarized light), the light is blocked by P polarizing filter 162A and thereby the liquid crystal portion becomes black. In contrast, in the liquid crystal portion (sub pixel) that is turned off, since light that entered from S polarizing filter 164A changes its polarized state, the light transmitted through the liquid crystal portion (sub pixel) becomes the P polarized component and thereby the liquid crystal portion becomes white. In the liquid crystal portion (sub pixel) that is caused to be the intermediate state, the polarization angle of light that entered from S polarizing filter 164A becomes intermediate between the P polarized light and the S polarized light (having both P polarized component and S polarized component). Only the P polarized component of the light is transmitted through P polarizing filter 162A of polarizing filter 162. Thus, by varying the voltage applied to the liquid crystal analogously corresponding to the pixel value and modulating the polarization angle of the incident light, the gradation control can be accomplished.

In addition, the drive circuit receives the second image signal with respect to the S polarized image shown in FIG. 6 as the QI multiplexed signal and performs the gradation control for the liquid crystal portion corresponding to sub pixels on even-numbered row of liquid crystal section 163. Although the gradation control for sub pixels on even-numbered row is the same as that for sub pixels on odd-numbered row, the latter is different from the former in that the incident light is the P polarized light and only the S polarized component of the light that is modulated by the liquid crystal is transmitted.

Thus, in the liquid crystal panel unit shown in FIG. 10, sub pixels on odd-numbered row display an image with the P polarized component and sub pixels on even-numbered row display an image with the S polarized component. As the image of the P polarized component, the P polarized image shown in FIG. 6 is displayed; as the image of the S polarized component, the S polarized image shown in FIG. 6 is displayed. Thus, switching between the two states of the first display state and the second display state can be performed.

In polarizing filter 162,164 shown in FIG. 11D, the P polarizing filters and the S polarizing filters may be arranged in other than the above-described shape. For example, the P polarizing filters and S polarizing filters may be arranged in a zigzag shape.

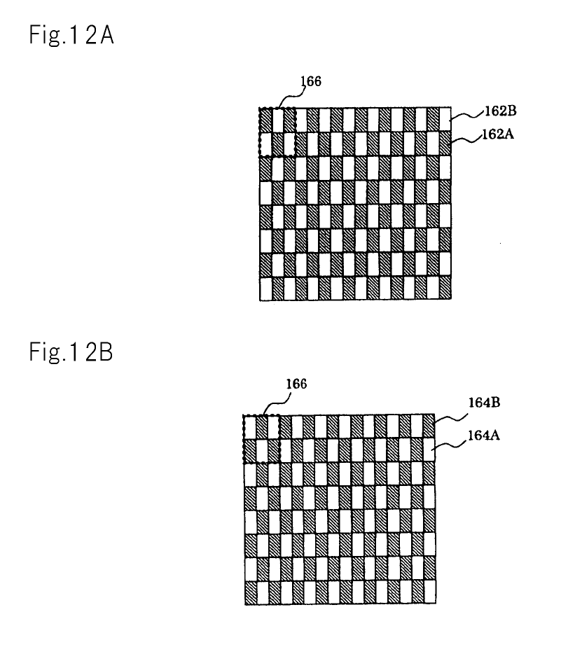

FIG. 12A and FIG. 12B show examples of polarizing filters 162, 164 in which P polarized filters and S polarizing filters are arranged in a zigzag shape.

In polarizing filter 162, from among sub pixels in two rows and three columns that make up pixel 166, P polarizing filters 162A are arranged in areas corresponding to a sub pixel in the first row and first column, a sub pixel in the second row and second column, and a sub pixel in the first row and third column; S polarizing filters 162B are arranged in areas corresponding to the remaining three sub pixels.

In contrast, in polarizing filter 164, from among sub pixels in two rows and three columns that make up pixel 166, S polarizing filters 164A are arranged in areas corresponding to a sub pixel in the first row and first column, a sub pixel in the second row and second column, and a sub pixel at the first row and third column; P polarizing filters 164B are arranged in areas corresponding to the remaining three sub pixels.

In the first display state, the first image and the second image are alternately displayed on respective portions of a checker pattern of the liquid crystal section, one portion on which the first image is displayed corresponding to sub pixels on which the P polarizing filters of polarizing filter 162 are arranged and corresponding to sub pixels on which the S polarizing filters of polarizing filter 164 are arranged, another portion on which the second image is displayed corresponding to sub pixels on which the S polarizing filters of polarizing filter 162 are arranged and corresponding to sub pixels on which the P polarizing filters of polarizing filter 164 are arranged. In the second display state, the first image and the second image are reversely displayed. In such a zigzag pattern, switching between the two states of the first display state and the second display state can be performed.

Next, a specific structure of optical shutter 14 will be described.

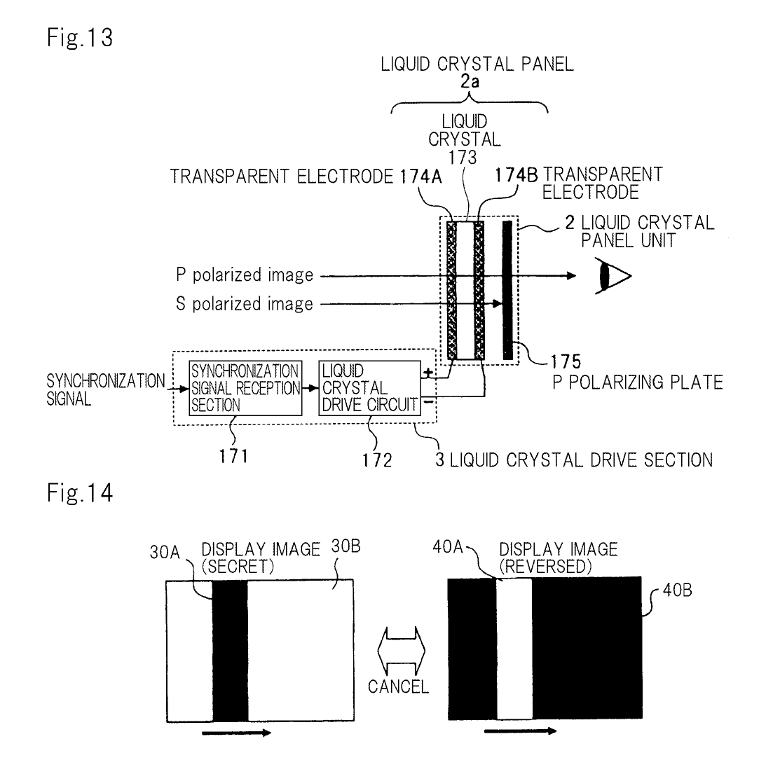

FIG. 13 is a block diagram showing an exemplary structure of optical shutter 14 that composes the image display system shown in FIG. 5.

Referring to FIG. 13, optical shutter 14 is one embodiment of an optical shutter that allows a secret image displayed on display means 13 to be observed and includes liquid crystal panel unit 2 and liquid crystal drive section 3 that drives the liquid crystal panel unit. Liquid crystal drive section 3 is composed of synchronization signal reception section 171 and liquid crystal drive circuit 172. Liquid crystal panel unit 2 includes liquid crystal panel 2a that sandwiches liquid crystal 173 with two transparent electrodes 174A, 174B, and P polarizing plate175 arranged on an emitting surface side of liquid crystal panel 2a.

Synchronization signal reception section 171 is a section that receives the synchronization signal from multiplexing section 12 shown in FIG. 5 and supplies the received synchronization signal as a control signal for liquid crystal panel unit 2 to liquid crystal drive circuit 172. The synchronization signal represents a switching timing of a secret image and a reversed image of the P polarized image or S polarized image shown in FIG. 6. In this example, multiplexing section 12 supplies a P polarized light synchronization signal that represents a switching timing of a secret image and a reversed image of the P polarized image to synchronization signal reception section 171. While a secret image is displayed with the P polarized light, the P polarized light synchronization signal remains in the high level; while a reversed image is displayed with the P polarized light, the P polarized light synchronization signal remains in the low level.

While the P polarized light synchronization signal remains in the high level, liquid crystal drive circuit 172 supplies a voltage that causes liquid crystal 173 to be turned on between transparent electrodes174A, 174B. In contrast, while the P polarized light synchronization signal remains in the low level, liquid crystal drive circuit 172 supplies a voltage that causes liquid crystal 173 to be turned off (for example, a voltage of 0 V) between transparent electrodes174A, 174B.

If liquid crystal 173 remains in the on state, an incident light is transmitted through liquid crystal panel 2a with the polarized state being maintained. In this case, both an image light of the P polarized component and an image light of the S polarized component that pass through display means 13 are transmitted through liquid crystal panel 2a. The image light of the S polarized component of those transmitted through liquid crystal panel 2a is blocked by P polarizing plate175, whereas the image light with the P polarized component is transmitted through P polarizing plate175.

In contrast, if liquid crystal 173 remains in the off state, the polarized state of incident light changes (the polarization direction changes by 90 degrees). In other words, if light of S polarized component enters liquid crystal panel 2a, the polarized component of light that is emitted from liquid crystal panel 2a becomes the P polarized component. If light of P polarized component enters liquid crystal panel 2a, the polarized component of light that is emitted from liquid crystal panel 2a becomes the S polarized component. In such a manner, an image light of the P polarized component and an image light of the S polarized component that passes through display means 13 are converted into an image light of the S polarized component and an image light of the P polarized component, respectively, by liquid crystal panel 2a. The image light with the S polarized component of those emitted from liquid crystal panel 2a is blocked by P polarizing plate175, whereas the image light of the P polarized component is transmitted through P polarizing plate175.

Optical shutter 14 shown in FIG. 13 can control transmission and blockage of each of the S polarized light and P polarized light. By turning on liquid crystal 173, an image of the P polarized component of those displayed on display means 13 can be observed.

In contrast, by turning off liquid crystal 173, an image of the S polarized component of those displayed on display means 13 can be observed.

Since on/off control of liquid crystal 173 synchronizes with switching timings of a secret image and a reversed image of the P polarized image or S polarized image, if a display image on display means 13 is viewed through optical shutter 14, only the secret image is sensed. If optical shutter 14 is not used, a gray image in which the secret image and the reversed image are temporally or spatially fused is sensed.

Even if an S polarizing plate is used instead of P polarizing plate175 in optical shutter 14 shown in FIG. 13, the operation that is the same as the above-described operation can be accomplished.

According to the above-described image display system according to this exemplary embodiment, if the optical shutter is not used, in the first display state, an image (gray image) in which a secret image (P polarized light) and a reversed image (S polarized light) are spatially fused is observed; in the second display state, an image (grey image) in which a reversed image (P polarized light) and a secret image (S polarized light) are spatially fused is observed. In the case in which the optical shutter is not used, if switching between the first display state and the second display state is performed, a gray image is switched to a gray image. Since the difference of the luminances of these gray images is sufficiently smaller than that of images in the case in which a white image and a black image are alternately displayed, the occurrence of flickers can be suppressed.

In the structure that controls the polarization separation state of the optical shutter in synchronization with a switching timing between the first display state and the second display state in the display means, it is difficult to forge the optical shutter in comparison with the image display devices described in Patent Literature 1 and Patent Literature 2. Thus, a secretly glancing at a display image through a forged optical shutter or the like can be suppressed.

In addition, if a moving image is displayed, a false contour sensed on the moving image displayed with the first polarized light is cancelled by a false contour sensed on the moving image displayed with the second polarized light. Thus, since the sense of false contours can be suppressed, surreptitiously glancing at a secret image (Q) can be prevented, resulting in providing an image display system having a high secrecy.

In the following, the theory of how the occurrence of a false contour is suppressed will be specifically described.

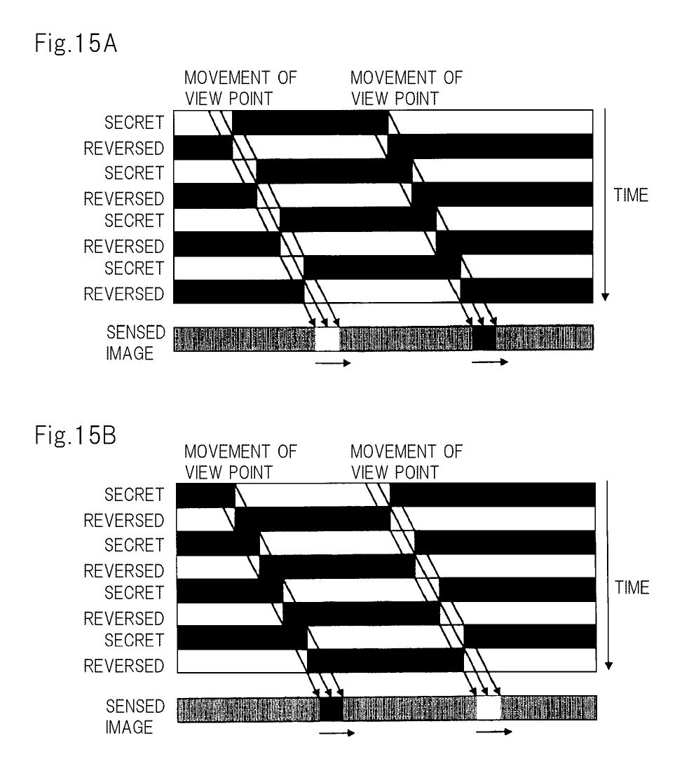

FIG. 14 is a schematic diagram showing an example of a moving image displayed on the display means. FIG. 15A is a schematic diagram showing the state in which images of particular lines are arranged in the order in which they are displayed, namely in time series in the case in which the moving image shown in FIG. 14 is a moving image of the P polarized light. FIG. 15B is a schematic diagram showing the state in which images of particular lines are arranged in the order in which they are displayed, namely in time series in the case in which the moving image shown in FIG. 14 is a moving image of the S polarized light.

In FIG. 14, an exemplary image on the left represents a moving image of a secret image (Q), whereas an exemplary image on the right represents a moving image of a reversed image (I). In the moving image of the secret image (Q), black stripe 30A that extends vertically moves from left to right. In the moving image of the reversed image (I), white stripe 40A that extends vertically moves from left to right. When the moving image of the secret image (Q) and the moving image of the reversed image (I) are alternately observed, a gray moving image is observed as a sensed image.

The display means displays a moving image of the secret image (Q) and the reversed image (I) shown in FIG. 14 with respect to the P polarized image. In this case, as shown in FIG. 15A, the view point of the observer on the moving image moves along the boundary of black stripe 30A and white area 40B and the boundary between white stripe 40A and black area 40B. Consequently, taking into account only the P polarized image, a white contour and a black false contour are sensed as a sensed image.

In addition, the display means displays a moving image of the secret image (Q) and the reversed image (I) shown in FIG. 14 with respect to the S polarized image. In this case, as shown in FIG. 15B, the view point of the observer on the moving image moves along the boundary of black stripe 30A and white area 40B and the boundary of white stripe 40A and black area 40B. Consequently, taking into account only the S polarized image, a white contour and a black false contour are sensed as a sensed image.

The white false contour and the black false contour of the sensed image (P polarized image) shown in FIG. 15A are cancelled by the black false contour and the white false contour of the sensed image (S polarized image) shown in FIG. 15B, respectively. Thus, since the false contour of the secret image (Q) is not sensed, surreptitiously glancing at the secret image can be prevented.

The structure of the display system according to the above-described exemplary embodiment can be appropriately changed. For example, the execution sequence of first display state T1 and second display state T2 in display period T shown in FIG. 6 may be the same in each display period T or different in every display period T.

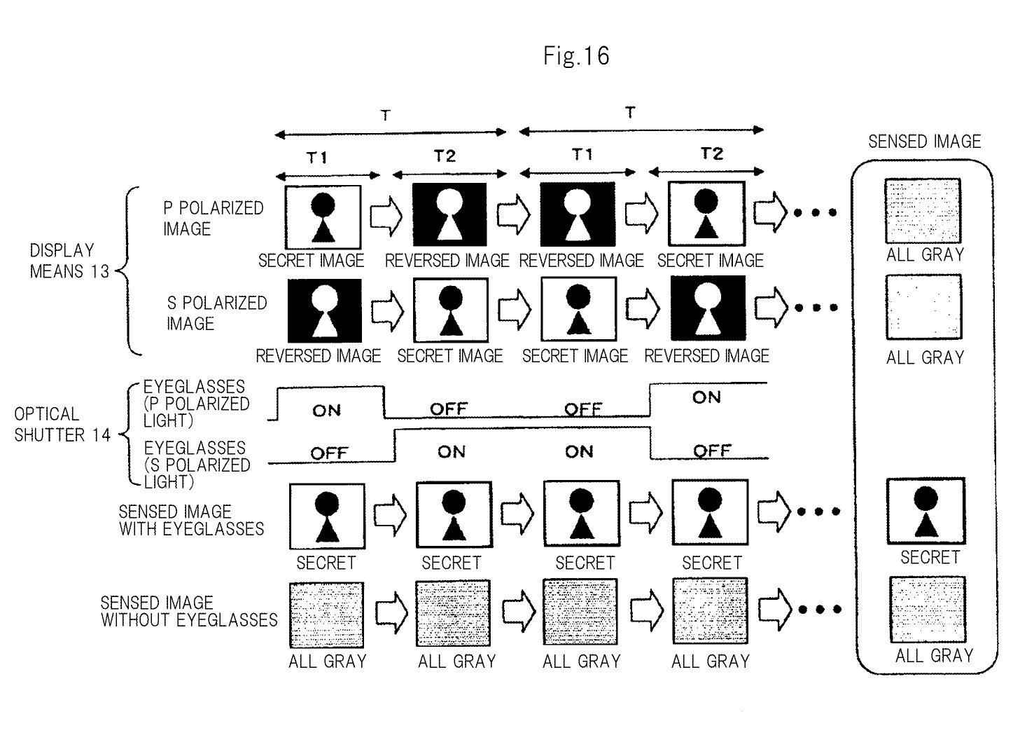

FIG. 16 is a schematic diagram that describes the operation of the image display system in the case in which the execution sequence of the first and second display states in an odd-numbered display period is different from that in an even-numbered display period.

Referring to FIG. 16, in the odd-numbered display period T, the first display state in which a secret image (Q) is displayed with the P polarized light and a reversed image (I) is displayed with the S polarized light is executed and then the second display state in which the reversed image (I) is displayed with the P polarized light and the secret image (Q) is displayed with the S polarized light is executed.

In contrast, in the even-numbered display period T, the second display state is executed and then the first display state is executed. In this display operation, when the on/off control of optical shutter 14 is performed in synchronization with switching timings between the first and second display states of the P polarized image and S polarized image, the secret image (Q) can be observed only through optical shutter 14.

Thus, by changing the switching timings between the first and second display states for every display period T, it becomes difficult to forge optical shutter 14. However, taking into account the critical fusion frequency, if the same images (for example, secret image (Q) of the P polarized light, or the like) continue at boundaries of the display periods (for example, between the odd-numbered display period T and the even-numbered display period, or the like) shown in FIG. 16, when images are viewed through an optical filter that transmits the P polarized light or S polarized light, since the display frequencies of the secret image (Q) and the reversed image (I) becomes substantially lower and since there may be a case in which the secret image is surreptitiously glanced at, caution should be exercised. To prevent this problem, each display period T needs to be short.

### Second Exemplary Embodiment

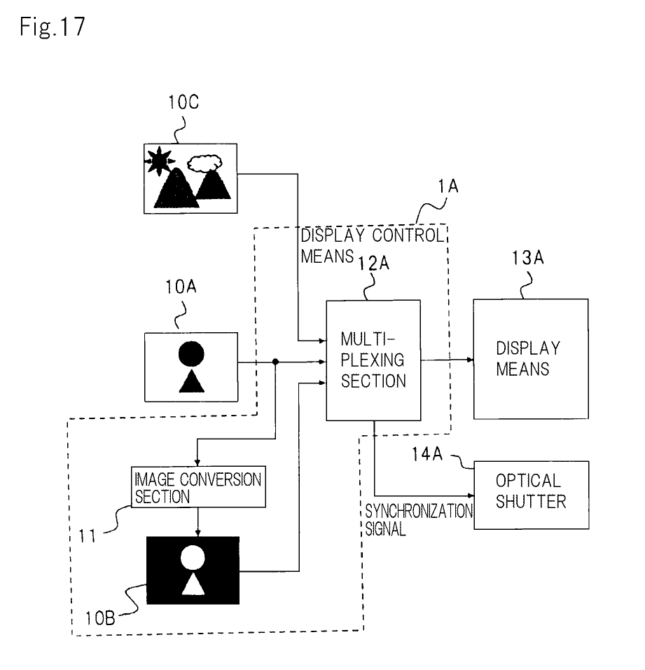

FIG. 17 is a block diagram showing the structure of an image display system according to a second exemplary embodiment of the present invention.

Referring to FIG. 17, the image display system according to this exemplary embodiment includes display means 13A, display control means 1A that controls the display operation of display means 13A for an image, and optical shutter 14A that serves to observe an image (still image or moving image) displayed on display means 13A.

Display means 13A displays at different timings three display states of a first display state in which a first image (Q) is displayed with a first polarized light and a second image (I) that cancels the first image is displayed with a second polarized light that differs from the first polarized light in polarized components, a second display state in which the second image (I) is displayed with the first polarized light and the first image (Q) is displayed with the second polarized light, and a third display state in which a third image (P) that is different from the first image (Q) is displayed with the first polarized light and the second polarized light.

Optical shutter 14A is structured such that it transmits the first polarized light and blocks the second polarized light in the first display state, that it transmits the second polarized light and blocks the first polarized light in the second display state, and such that it blocks the first and second polarized lights in the third display state.

Display control means 1A controls switching among the first to third display states on display means 13A. As a specific exemplary circuit that performs switching control, display control means 1A includes image conversion section 11 and multiplexing section 12A. However, it should be noted that display control means 1A is not limited to the circuit that is composed of image conversion section 11 and multiplexing section 12A, rather display control means 1A may be composed of another circuit as long as it can control switching among the first to third display states.

In the example shown in FIG. 17, image signals 10A, 10C are supplied to display control means 1. Image signals 10A, 10C are image signals that are supplied frame by frame for example from an external image processing device (such as a personal computer) or an image processing circuit disposed in the system. Image signal 10A is supplied to each of image conversion section 11 and multiplexing section 12A. Image signal 10C is supplied to multiplexing section 12A. Image conversion section 11 is the same as that described in the first exemplary embodiment.

Multiplexing section 12A temporally or spatially multiplexes the first image (Q) based on inputted image signal 10A, the second image (I) based on inputted image signal 10B, and the third image (P) based on inputted image signal 10C and generates a QIP multiplexed image. In this example, it is assumed that the first image (Q) is a secret image, the second image (I) is a reversed image, and the third image (P) is a public image. A QIP multiplexed image signal that is outputted from multiplexing section 12A is supplied to display means 13A. In addition, multiplexing section 12A generates a synchronization signal that represents a switching timing of Q, I, and P in the QIP multiplexed image signal. The synchronization signal that is outputted from multiplexing section 12A is supplied to optical shutter 14A.

Display means 13A displays an image with a first polarized light and an image with a second polarized light based on the QIP multiplexed image signal supplied from multiplexing section 12A. In this example, for convenience, the first polarized light is referred to as a P polarized light, whereas the second polarized light is referred to as an S polarized light. Of course, it may be possible that the first polarized light is referred to as an S polarized light, whereas the second polarized light is referred to as a P polarized light. In this case, the operation can be described such that the S polarized light is substituted for the P polarized light, whereas the P polarized light is substituted for the S polarized light.

Display means 13A performs switching among the first display state in which the secret image (Q) is displayed with the P polarized light and the reversed image (I) is displayed with the S polarized light, the second display state in which the reversed image (I) is displayed with the P polarized light and the secret image (Q) is displayed with the S polarized light, and the third display state in which the public image (P) is displayed with the P polarized light and the S polarized light. Switching among the first to third display states synchronizes with the synchronization signal that is outputted from multiplexing section 12A.

Optical shutter 14A is an optical shutter that can switch among a first polarization separation state in which the P polarized component is transmitted and the S polarized component is blocked, a second polarization separation state in which the S polarized component is transmitted and the P polarized component is blocked, and a third polarization separation state in which both the S polarized component and the P polarized component are blocked. The shape of the optical shutter may be an eyeglass type, a card type, a screen type, a window type, or the like. Switching among the first to third polarization separation states is performed based on the synchronization signal that is outputted from multiplexing section 12A. Specifically, if display means 13A operates in the first display state, optical shutter 14A operates in the first polarization separation state; if display means 13A operates in the second display state, optical shutter 14A operates in the second polarization separation state; and if display means 13A operates in the third display state, optical shutter 14A operates in the third polarization separation state.

Next, the operation of the image display system according to this exemplary embodiment will be described.

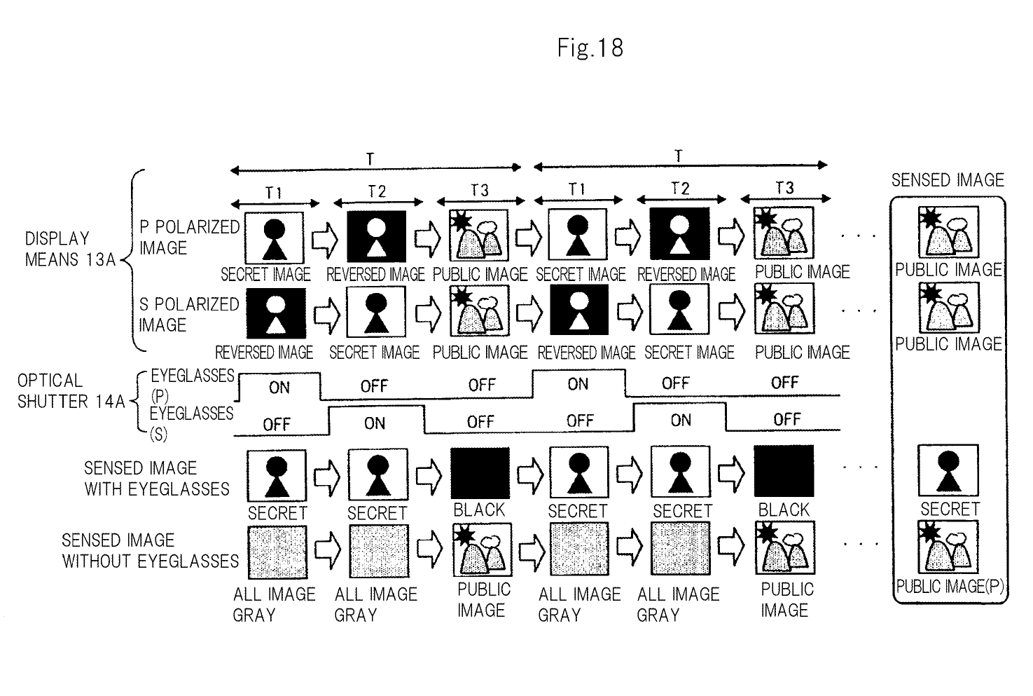

FIG. 18 is a schematic diagram that describes the theory of operation of the image display system shown in FIG. 17. Referring to FIG. 18, in display period T, switching is performed among first display state T1, second display state T2, and third display state T3.

In first display state T1, display means 13A displays the secret image (Q) with the P polarized light and the reversed image (I) with the S polarized light. Moreover, in first display state T1, optical shutter 14A transmits the P polarized component and blocks the S polarized component. In this case, of the secret image (Q) of the P polarized light and the reversed image (I) of the S polarized light that are displayed on display means 13A, only the secret image (Q) of the P polarized light is transmitted through optical shutter 14A. Thus, in first display state T1, if optical shutter 14A is used, the secret image (Q) becomes a sensed image (a sensed image with eyeglasses shown in FIG. 18). In contrast, if optical shutter 14A is not used, since a spatially combined image of the secret image (Q) of the P polarized light and the reversed image (I) of the S polarized light that is displayed on display means 13A is observed, a gray image becomes a sensed image (a sensed image without eyeglasses shown in FIG. 18).

In second display state T2, display means 13A displays the reversed image (I) with the P polarized light and the secret image (Q) with the S polarized light. Moreover, in second display state T2, optical shutter 14A transmits the S polarized component and blocks the P polarized component. In this case, of the reversed image (I) of the P polarized light and the secret image (Q) of the S polarized light that are displayed on display means 13A, only the secret image (Q) of the S polarized light is transmitted through optical shutter 14A. Thus, in second display state T2, if optical shutter 14A is used, the secret image (Q) becomes a perspective image (a sensed image with eyeglasses shown in FIG. 18). If optical shutter 14A is not used, like the case in above-described first display state T1, a gray image becomes a sensed image (a sensed image without eyeglasses shown in FIG. 18).

In third display state T3, display means 13A displays the public image (P) is displayed with the P polarized light and the S polarized light. In addition, in third display state T2, optical shutter 14A blocks both the P polarized component and the S polarized component. In this case, both the public image (P) of the P polarized light and the public image (P) of the S polarized light are blocked by optical shutter 14A. Thus, in third display state T3, if optical shutter 14A is used, a black screen becomes a sensed image (a sensed image with eyeglasses in FIG. 18). If optical shutter 14A is not used, the public image (P) becomes a sensed image (a sensed image without eyeglasses in FIG. 18).

In the image display system according to this exemplary embodiment, display period T needs to be a period equal to or greater than a critical fusion frequency that depends on the contrast ratio of images having the highest contrast ratio of pairs of secret image (Q) and reversed image (I), reversed image (I) and public image (P), and public image (P) and secret image (Q) and the average luminance of all of the images. Multiplexing section 12A refers to the characteristic data, that is stored in a storage section and that is with respect to a characteristic diagram as shown in FIG. 7, to obtain the critical fusion frequency in an area (an area in which the difference between brightness and darkness is the largest) in which the contrast ratio between images is the closest to 1. Thereafter, multiplexing section 12A generates a QIP multiplexed image such that switching among the first to third display states is performed on display means 13A in display period T equal to or greater than the obtained critical fusion frequency. Thus, the secret image (Q), the reversed image (I), and public image (P) that are displayed with the S polarized light or the P polarized light on display means 13A are always temporally fused.

Thus, if a display image is viewed not through optical shutter 14, since a gray image in the first display state, a gray image in the second display state, and the public image (P) in the third display state are temporally fused, therefore the public image is sensed. If a display image on display means 13A is viewed through an optical filter that transmits only the P polarized light (S polarized light), since the secret image (Q) of the P polarized light (S polarized light) and the reversed image (I) of the P polarized light (S polarized light) are temporally fused, thus, the case in which the display image is viewed not through optical shutter 14, the public image (P) is sensed. If the display image is viewed through optical shutter 14, the secret image (Q) of the P polarized light and the secret image (Q) of the S polarized light are temporally fused and thus the secret image is sensed. Thus, since the secret image (Q) can be viewed only through optical shutter 14, viewing of the secret image by a surreptitiously glance can be prevented.

In display period T shown in FIG. 18, switching among the first to third display states can be performed at any timing. At this point, to prevent viewing of the secret image by a surreptitious glance through the use of an optical filter that transmits only the P polarized light (S polarized light), it is preferred that the temporal integration value of the luminances in first display state T1 and the temporal integration value of the luminances in second display state T2 become the same. As a method of how to set up the luminances in T1 and T2, assuming that the display duration in T1 is denoted by t1 and the display duration in T2 is denoted by t2, these luminances can be obtained by substituting t and T-t into t1 and t2 in the formula given by the above-described [Expression 2]

Alternatively, in display period T, the first display state may be executed n times (where n is any positive integer), the second display state may be executed m times (where m is any positive integer), and the third display state may be executed s times (where s is any positive integer). Further alternatively, in display period T, switching among the first to third display states may be performed multiple times. In this case, likewise, to prevent viewing of the secret image by a surreptitious glance through the use of an optical filter that transmits only the P polarized light or the S polarized light, it is preferred to set up the luminances of the secret image (Q) and the reversed image (I) in T1 and T2 such that the temporal integration value of the luminances in the total duration in which first display state T1 in display period T is executed becomes the same as the temporal integration value of the luminance in the total duration in which second display state T2 is executed in display period T. As a method of how to set up the luminances, they can be obtained from the formula shown in [Expression 2]. The contrast of the pubic image (P) that is sensed if it does not pass through optical shutter 14A can be adjusted depending on the ratio of the total duration during which the third display state is executed to the display duration T. If the duration during which the third display state is executed is close to display period T (time ratio is large), the contrast of the public image (P) can be raised. In this case, when viewed through optical shutter 14A, since the ratio of the display duration of the secret image (Q) to the display duration T becomes small, the absolute brightness of the secret image (Q) falls. This is because of the characteristic of the human eye in which, when the eye sees a dark image, since their pupil dilates, the eye does not sense that the image is very dark.

In the image display system according to this exemplary embodiment, the first to third exemplary structures of display means 13 of the first exemplary embodiment can be applied to display means 13A.

Next, a specific structure of optical shutter 14A will be described.

(First Exemplary Structure of Optical Shutter 14a)

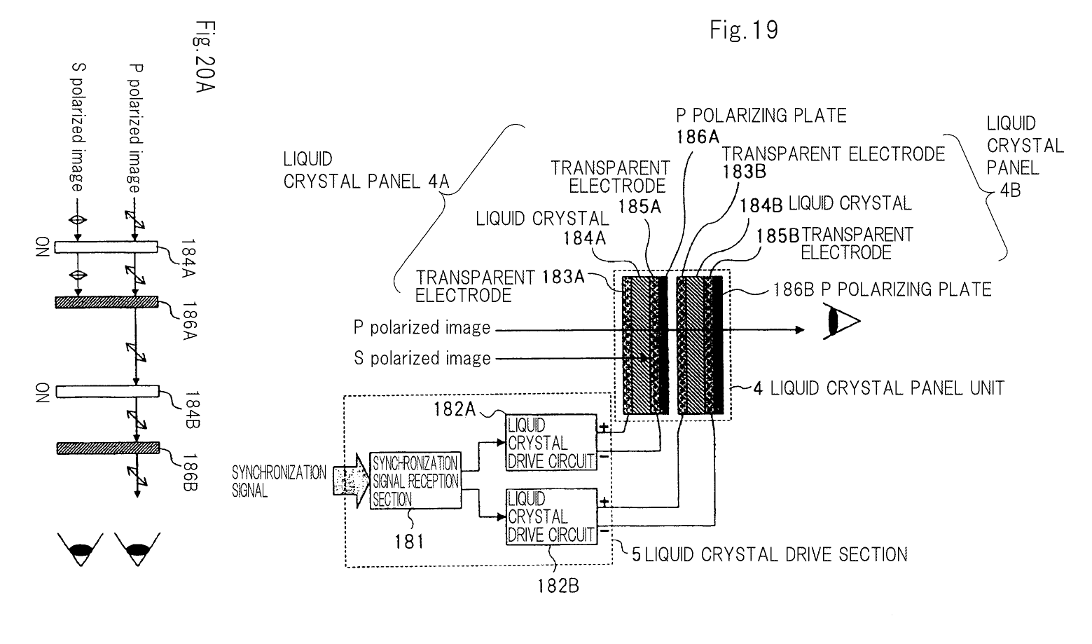

FIG. 19 is a block diagram showing a first exemplary structure of optical shutter 14A that makes up the image display system shown in FIG. 17.

Optical shutter 14 shown in FIG. 19 is an embodiment of an optical shutter that performs switching among a first polarization separation state in which, of the P polarized image and the S polarized image that are emitted from display means 13A, the P polarized image is transmitted and the S polarized image is blocked, a second polarization separation state in which the S polarized image is transmitted and the P polarized image is blocked, and a third polarization separation state in which both the P polarized image and the S polarized image are blocked (not transmitted) in synchronization with switching among the first to third display states on display means 13A.

Optical shutter 14A includes liquid crystal panel unit 4 and liquid crystal drive section 5 that drives liquid crystal panel unit 4. Liquid crystal drive section 5 includes synchronization signal reception section 181 and liquid crystal drive circuits 182A, 182B. Liquid crystal panel unit 4 includes liquid crystal panel 4A that sandwiches liquid crystal 184A with two transparent electrodes 183A, 185A; a liquid crystal panel 4B that sandwiches liquid crystal 184B with two transparent electrodes 183B, 185B; P polarizing plate186A arranged on an emitting surface side of liquid crystal panel 4A; and P polarizing plate186B arranged on an emitting surface side of liquid crystal panel 4B. Liquid crystal panel 4A is arranged on an incident surface side of the polarized image emitted from display means 13A, whereas liquid crystal panel 4B is arranged on an emitting surface side of liquid crystal panel 4A.

Synchronization signal reception section 181 is a section that receives the synchronization signal from multiplexing section 12A shown in FIG. 17 and generates a first control signal (P polarized light control signal) for liquid crystal panel 4A and a second control signal (S polarized light control signal) for liquid crystal panel 4B based on the received synchronization signal. The first control signal is supplied to liquid crystal drive circuit 182, whereas the second control signal is supplied to liquid crystal drive circuit 182B.

The synchronization signal includes a P polarized light synchronization signal that represents switching timings in which the secret image with the P polarized image shown in FIG. 18 is displayed and not displayed and an S polarized light synchronization signal that represents switching timings in which the secret image with the S polarized image shown in FIG. 18 is displayed and not displayed. The P polarized light synchronization signal and the S polarized light synchronization signal may be independently supplied to synchronization signal reception section 181. Alternatively, a synchronization signal in which the P polarized light synchronization signal and the S polarized light synchronization signal are multiplexed may be supplied to synchronization signal reception section 181. The multiplexed synchronization signal of the P polarized light synchronization signal and the S polarized light synchronization signal is composed of for example a 2-bit signal.

In the 2-bit multiplexing synchronization signal, for example, a signal of “00” represents the third display state, a signal of “01” represents the first display state, and a signal of “10” represents the second display state. The P polarized light control signal (first control signal) remains in the high level during the first display state and remains in the low level during the second and third display states. The S polarized light control signal (second control signal) remains in the high level during the second display state and remains in the low level during the first and third display states.

While the P polarized light synchronization signal remains in the high level, liquid crystal drive circuit 182A supplies a voltage that causes liquid crystal 184A to be turned on between transparent electrodes183A, 185A. In contrast, while the P polarized light synchronization signal remains in the low level, liquid crystal drive circuit 182A supplies a voltage that causes liquid crystal 184A to be turned off (for example, a voltage of 0 V) between transparent electrodes183A, 185A.

If liquid crystal 184A remains in the on state, an incident light is transmitted through liquid crystal panel 4A, in which the polarized state is maintained. An image light with the S polarized component that passes through display means 13A is blocked by P polarizing plate 186A, whereas the image light with the P polarized component is transmitted through P polarizing plate 186A.

In contrast, if liquid crystal 184A remains in the off state, the polarized state of the incident light changes (the polarization direction changes by 90 degrees). In other words, if light of the S polarized component enters liquid crystal panel 4A, the polarized component of the light that is emitted from liquid crystal panel 4A becomes the P polarized component. If light of the P polarized component enters liquid crystal panel 4A, the polarized component of the light that is emitted from liquid crystal panel 4A becomes the S polarized component. In such a manner, the image light of the P polarized component and the image light of the S polarized component that are emitted from display means 13A are converted into image light of the S polarized component and image light of the P polarized component, respectively, by liquid crystal panel 4A. Thus, the image light of the P polarized component emitted from display means 13A is blocked by P polarizing plate 186A, whereas the image light of the S polarized component is transmitted through P polarizing plate 186A.

While the S polarized light synchronization signal remains in the high level, liquid crystal drive circuit 182B supplies a voltage that causes liquid crystal 184B to be turned on between transparent electrodes 183B, 185B. In contrast, while the S polarized light synchronization signal remains in the low level, liquid crystal drive circuit 182B supplies a voltage that causes liquid crystal 184B to be turned off (for example, a voltage of 0 V) between transparent electrodes 183B, 185B.

If liquid crystal 184B remains in the on state, an incident light is transmitted through liquid crystal panel 4A, in which the polarized state is maintained. In this case, the image light of the P polarized component that passes through liquid crystal panel 4A is transmitted through liquid crystal panel 4B and is also transmitted through P polarizing plate 186B.

In contrast, if liquid crystal 184B remains in the off state, the polarized state of the incident light changes (the polarization direction changes by 90 degrees). In other words, the image light of the P polarized component is converted into image light of the S polarized component by liquid crystal panel 4B and blocked by P polarizing plate186B. In other words, both image light of the P polarized component and image light of the S polarized component emitted from display means 13A are not transmitted through liquid crystal panel 4B regardless of whether liquid crystal 184B is turned on or off.

With optical shutter 14A shown in FIG. 19, since transmission and blockage of each of the S polarized light and P polarized light can be controlled, switching among the first to third polarization separation states can be performed.

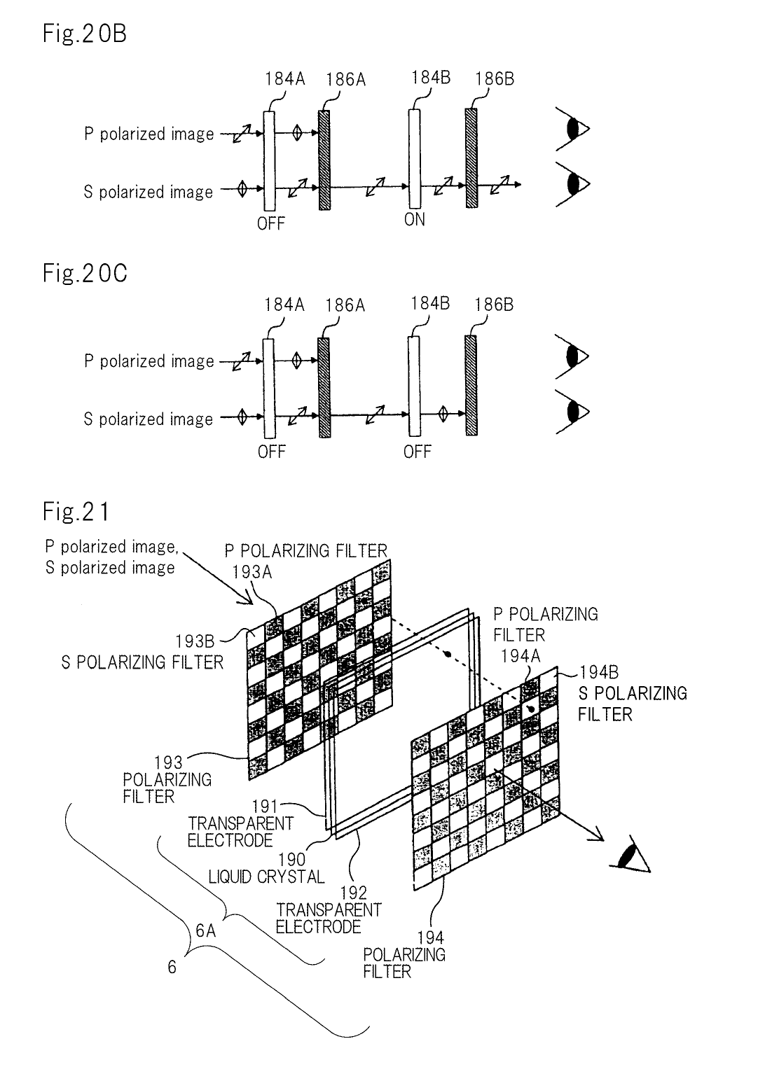

FIG. 20A to FIG. 20C are schematic diagrams that describe the operation of optical shutter 14A shown in FIG. 19. FIG. 20A is a schematic diagram showing a first polarization separation state, FIG. 20 is a schematic diagram showing a second polarization separation state, and FIG. 20C is a schematic diagram showing a third polarization separation state.

If both liquid crystals 184A, 184B are turned on as shown in FIG. 20A, the P polarized image is observed through the optical shutter and the S polarized image is blocked by the optical shutter. On the other hand, as shown in FIG. 20B, if liquid crystal 184A is turned off and liquid crystal 184B is turned on, the S polarized image is observed through the optical shutter and the P polarized image is blocked by the optical shutter. On the other hand, if both liquid crystals 184A, 184B are turned off, both the P polarized image and the S polarized image are blocked by the optical shutter.

Since the switching timings among the first to third polarization separation states shown in FIG. 20A to FIG. 20C synchronize with the switching timings among the first to third display states on display means 13A, if a display image on display means 13A is observed through the optical shutter, only the secret image is sensed. If the optical shutter is not used, a gray image in which the secret image and the reversed image are fused or in which these images and the public image are fused is sensed.

With S polarizing plates instead of P polarizing plates186A, 186B in optical shutter 14 shown in FIG. 19, the operation that is the same as the above-described operation can be accomplished. In this case, if both liquid crystals 184A, 184B are turned on, the optical shutter becomes the second polarization separation state. If liquid crystal 184A is turned off and liquid crystal 184B is turned on, the optical shutter becomes the first polarization separation state. If liquid crystal 184B is turned off, the optical shutter becomes the third polarization separation state regardless of the state of liquid crystal 184A.

A P polarizing plate and an S polarizing plate may be used for 186A and 186B in optical shutter 14A shown in FIG. 19. In this case, if liquid crystal 184A is turned on and liquid crystal 184B is turned off, the optical shutter becomes the first polarization separation state. If both liquid crystal 184A and liquid crystal 184B are turned off, the optical shutter becomes the second polarization separation state. If liquid crystal 184B is turned off, the optical shutter becomes the third polarization separation state regardless of the state of liquid crystal 184A.

An S polarizing plate and a P polarizing plate may be used for 186A and 186B, respectively, in optical shutter 14A shown in FIG. 19. In this case, if both liquid crystals 184A, 184B are turned off, the optical shutter becomes the first polarizing separation state. If liquid crystal 184A is turned on and liquid crystal 184B is turned off, the optical shutter becomes the second polarization separation state. If liquid crystal 184B is turned on, the optical shutter becomes the third polarization separation state regardless of the state of liquid crystal 184A.

(Second Exemplary Structure of Optical Shutter 14a)

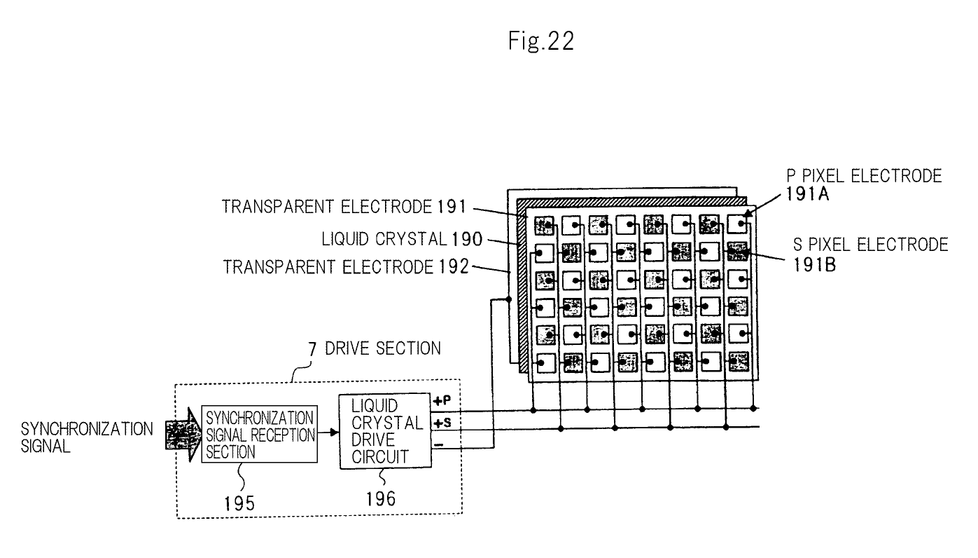

FIG. 21 is a block diagram showing a second exemplary structure of optical shutter 14A that composes the image display system shown in FIG. 17. FIG. 22 is a block diagram showing a drive section and an electrode section of a liquid crystal panel unit in optical shutter 14A shown in FIG. 21.

As shown in FIG. 21, liquid crystal panel unit 6 includes: liquid crystal panel 6A in which liquid crystal 190 is sandwiches with two transparent electrodes 191, 192; polarizing filter 193 that is arranged on an incident surface side of liquid crystal panel 6A; and polarizing plate 194 that is arranged on an emitting surface side of liquid crystal panel 6A.

As shown in FIG. 22, drive section 7 of liquid crystal panel unit 6 includes synchronization signal reception section 195 that receives a synchronization signal from multiplexing section 12A and that generates a polarized light control signal and liquid crystal drive circuit 196 that drives liquid crystal panel unit 6 based on the polarized light control signal.

Transparent electrode 191 is provided with a plurality of pixel electrodes arranged in a matrix shape. These pixel electrodes include P pixel electrodes 191A to which the P polarized light enters and S pixel electrodes 191B to which the S polarized light enters. P pixel electrodes 191A and S pixel electrodes 191B are arranged in a zigzag shape. P pixel electrodes 191A are connected to a “+P” terminal of liquid crystal drive circuit 196, whereas S pixel electrodes 191B are connected to an “+S” terminal of liquid crystal drive circuit 196. Transparent electrode 192 is a common electrode of each pixel electrode of transparent electrode 191 and is connected to a “−” terminal of liquid crystal drive circuit 196.

Polarizing filter 193 includes P polarizing filters 193A and S polarizing filters 193B. P polarizing filters 193A are arranged in areas corresponding to individual P pixel electrodes 191A of liquid crystal panel 6A in a zigzag shape. S polarizing filters 193B are arranged in areas corresponding to individual S pixel electrodes 191B of liquid crystal panel 6A in a zigzag shape.

Polarizing filter 194 includes P polarizing filters 194A and S polarizing filters 194B. P polarizing filters 194A are arranged in areas corresponding to individual S pixel electrodes 191B of liquid crystal panel 6A in a zigzag shape. S polarizing filters 194B are arranged in areas corresponding to individual P pixel electrodes 191A of liquid crystal panel 6A in a zigzag shape. P polarizing filters 194A face S polarizing filters 193B, whereas S polarizing filters 194B face P polarizing filters 193A. In other words, the arrangements of P polarizing filters 193A and S polarizing filters 193B on polarizing filter 193 are the reverse of the arrangements of P polarizing filters 194A and S polarizing filters 194B on polarizing filter 194.

Like the first exemplary structure, in optical shutter 14A of this exemplary structure, synchronization signal reception section 195 receives a 2-bit multiplexing synchronization signal from multiplexing section 12A and supplies a P polarized light control signal and an S polarized light control signal to liquid crystal drive circuit 196. The P polarized light control signal remains in the high level during the first display state, whereas it remains in the low level during the second and third display states. The S polarized light control signal remains in the high level during the second display state, whereas it remains in the low level during the first and third display states.

Liquid crystal drive circuit 196 controls the supply of a voltage to P pixel electrodes 191A based on the P polarized light control signal and the supply of a voltage to S pixel electrodes 191B based on the S polarized light control signal.

While the P polarized light control signal remains at the high level (first display state), in liquid crystal drive circuit 196, the voltage at the “+P” terminal is a voltage that causes the liquid crystal to be turned off (for example, a voltage of 0 V) and the voltage at the “+S” terminal is a voltage that causes the liquid crystal to be turned on. As a result, the liquid crystal of the first pixels corresponding to P pixel electrodes 191A is turned off, whereas the liquid crystal of the second pixels corresponding to S pixel electrodes 191B is turned on. In the pixels whose liquid crystal is turned off, the polarized state of the incident light changes (the polarizing direction changes by 90 degrees). In the pixels whose liquid crystal is turned on, the incident light is transmitted through the liquid crystal, in which the polarized state is maintained.

In the above-described state, image lights (P polarized light and S polarized light) that passes through display means 13A that operates in the first display state enters P polarizing filters 193A and S polarizing filters 193B. S polarizing filters 193B block the image light of the P polarized light and transmit the image light of the S polarized light. P polarizing filters 193A block the image light of the S polarized light and transmit the image light of the P polarized light.

The image light (P polarized light) that passes through P polarizing filters 193A enters the first pixels whose liquid crystal remains in the off state. The light that passes through the first pixels becomes the S polarized light. On the other hand, the image light that passes through the first pixels (S polarized light) is transmitted through S polarizing filters 194B. On the other hand, the image light (S polarized light) that passes through S polarizing filters 193B enters the second pixels whose liquid crystal remains in the on state. The image light (S polarized light) passes through the second pixels, in which the polarized state is maintained. The image light (S polarized light) that passes through the second pixels is blocked by P polarizing filters 194A. Such an operation accomplishes the first polarization separation state.

While the P polarized light control signal remains at the low level (second or third display state), in liquid crystal drive circuit 196, the voltages at the “+P” terminal and “+S” terminal are those that cause the liquid crystal to be turned on. As a result, both the liquid crystals of the first pixels (P pixel electrodes 191A) and the second pixels (S pixel electrodes 191B) are turned off.

In the above-described state, image lights (P polarized light and S polarized light) that pass through display means 13A that operates in the second or third display state enter P polarizing filters 193A and S polarizing filters 193B.

The image light (P polarized light) that passes through P polarizing filters 193A enters the first pixels whose liquid crystal remains in the on state. The entered image light (P polarized light) passes through the first pixels, in which the polarized state is maintained. The image light (P polarized light) that passes through the first pixels is blocked by S polarizing filters 194B. On the other hand, the image light (S polarized light) that passes through S polarizing filters 193B enters the second pixels whose liquid crystal remains in the on state. The image light (S polarized light) that passes through the second pixels, in which the polarized state is maintained. The image light (S polarized light) that passes through the second pixels is blocked by P polarizing filters 194A. Such an operation accomplishes the third polarization separation state.

While the S polarized light control signal remains at the high level (second display state), in liquid crystal drive circuit 196, the voltage at the “+P” terminal is a voltage that causes liquid crystal to be turned off and the voltage at the “+S” terminal is a voltage that causes liquid crystal to be turned on (for example, a voltage of 0 V). As a result, the liquid crystal of the first pixels corresponding to P pixel electrodes 191A is turned on, the liquid crystal of the second pixels corresponding to S pixel electrodes 191B is turned off.

In the above-described state, image lights (P polarized light and S polarized light) that pass through display means 13A that operates in the second display state enter P polarizing filter 193A and S polarizing filter 193B.

The image light (P polarized light) that passes through P polarizing filters 193A enters the first pixels whose liquid crystal remains in the off state. The entered image light (P polarized light) passes through the first pixels, in which the polarized state is maintained. The image light (P polarized light) that passes through the first pixels is blocked by S polarizing filters 194B. On the other hand, the image light (S polarized light) that passes through S polarizing filter 193B enters the second pixels whose liquid crystal remains in the on state. The light that passes through the second pixels becomes the P polarized light. The image light (P polarized light) that passes through the second pixels passes through P polarizing filters 194A. Such an operation accomplishes the second polarization separation state.

While the P polarized light control signal remains at the low level (first or third display state), in liquid crystal drive circuit 196, the voltages at the “+P” terminal and “+S” terminal are those that cause the liquid crystal to be turned on. As a result, the liquid crystals of the first pixels (P pixel electrodes 191A) and the second pixels (S pixel electrodes 191B) are turned off.

In the above-described state, image lights (P polarized light and S polarized light) that pass through display means 13A that operates in the second or third display state enter P polarizing filters 193A and S polarizing filters 193B.

The image light (P polarized light) that passes through P polarizing filters 193A enters the first pixels whose liquid crystal remains in the on state. The entered image light (P polarized light) passes through the first pixels, in which the polarized state is maintained. The image light (P polarized light) that passes through the first pixels is blocked by S polarizing filters 194B. On the other hand, the image light (S polarized light) that passes through S polarizing filters 193B enters the second pixels whose liquid crystal remains in the on state. The image light (S polarized light) passes through the second pixels, in which the polarized state is maintained. The image light (S polarized light) that passes through the second pixels is blocked by P polarizing filters 194A. Such an operation accomplishes the third polarization separation state.

The on/off control for the liquid crystal of the first pixels based on the above-described P polarized light control signal and the on/off control for the liquid crystal of the second pixels based on the S polarized light control signal allow switching among the first to third polarization separation states to be performed.

Since optical shutter 14A of this exemplary structure needs to have only one liquid crystal panel unit, this exemplary structure allows the optical shutter to become light and thin because it needs to have only one liquid crystal panel unit in comparison with the optical shutter of the first exemplary structure that needs to have two liquid crystal panel units.

In the image display system according to this exemplary embodiment as described above, in addition to the effect in which the problems of flickers, false contours, and forging can be solved, a public image having a stable image quality can be provided to a person who does not use the optical shutter.

### Third Exemplary Embodiment

Although the image display system according to a third exemplary embodiment of the present invention basically includes the same structure as the image display system according to the second exemplary embodiment shown in FIG. 17, they differ in the operations of multiplexing section 12A, display means 13A, and optical shutter 14A.

Multiplexing section 12A temporally or spatially multiplexes a first image (Q) based on inputted image signal 10A, a second image (I) based on inputted image signal 10B, and a third image (P) based on inputted image signal 10C and generates a QIP multiplexed image. In this example, it is assumed that the first image (Q) is a secret image, the second image (I) is a reversed image, and the third image (P) is a public image. A QIP multiplexed image signal that is outputted from multiplexing section 12A is supplied to display means 13A. In addition, multiplexing section 12 generates a synchronization signal that represents switching timings of Q, I, and P in the QIP multiplexed image signal. The synchronization signal that is outputted from multiplexing section 12A is supplied to optical shutter 14A.

Display means 13A displays an image with a first polarized light and an image with a second polarized light based on the QIP multiplexed image signal supplied from multiplexing section 12A. In this example, for convenience, the first polarized light is referred to as a P polarized light, whereas the second polarized light is referred to as an S polarized light. Of course, it may be possible that the first polarized light is referred to as an S polarized light, whereas the second polarized light is referred to as a P polarized light. In this case, the operation can be described such that the S polarized light is substituted for the P polarized light, whereas the P polarized light is substituted for the S polarized light.

Display means 13A performs switching between a first display state in which the secret image (Q) is displayed with the P polarized light and in which a combined image of the reversed image (I) and the public image (P) is displayed with the S polarized light and a second display state in which the combined image of the reversed image (I) and the public image (P) is displayed with the P polarized light and in which the secret image (Q) is displayed with the S polarized light. Switching between the first and second display states synchronizes with the synchronization signal that is outputted from multiplexing section 12A.

In the first display state, the combined image of the reversed image (I) and the public image of the P polarized light is an image in which the luminances are added in a luminance space for the corresponding pixels of the reversed image (I) and the public image (P). In the second display state, the combined image of the reversed image (I) and the public image (P) of the S polarized light is an image in which the luminances are added in the luminance space for corresponding pixels of the reversed image (I) and the public image (P).

If the luminances are added in the luminance space and the luminance of the reversed image (I) or the public image (P) is high, the luminance may exceed the display performance (dynamic range of the luminance) of display means 13A. The combined image of the reversed image (I) and the public image (P) can be displayed with a luminance that does not exceed the display performance of the display means in such a manner that after the luminances of the reversed image (I) and the public image (P) are lowered, they are added in the luminance space.

At this point, it should be noted that the luminance of the reversed image (I) needs to be lowered at the same ratio as the luminance of the public image (P) is lowered so that the reversed image and the secret image are cancelled. When the images are displayed without lowering the luminance of the secret image, since the reversed image (I) and the reversed image (I) are not cancelled. Therefore, if display means 13A is viewed not through optical shutter 14A, the secret image can be viewed, resulting in deteriorating the secrecy. If the luminance of the reversed image is lowered to 0.3 times, the luminance of the secret image also needs to be lowered to 0.3 times.

However, the ratio at which the luminance of the public image (P) is lowered does not need to be the same as the ratio at which the luminance of the reversed image (I) is lowered. If the luminance of the public image (P) is greater than that of the reversed image (I) or secret image (Q), the contrast of the public image (P) that is sensed when observed not through optical shutter 14A can be raised.

Optical shutter 14A is an optical shutter that can switch between a first polarization separation state in which the P polarized component is transmitted and in which the S polarized component is blocked and a second polarization separation state in which the S polarized component is transmitted and in which the P polarized component is blocked. The shape of the optical shutter may be an eyeglass type, a card type, a screen type, a window type, or the like. Switching between the first polarization separation state and the second polarization separation state is performed based on the synchronization signal that is outputted from multiplexing section 12A. Specifically, if display means 13A operates in the first display state, optical shutter 14A operates in the first polarization separation state; if display means 13A operates in the second display state, optical shutter 14A operates in the second polarization separation state.

Next, the operation of the image display system according to this exemplary embodiment will be described.

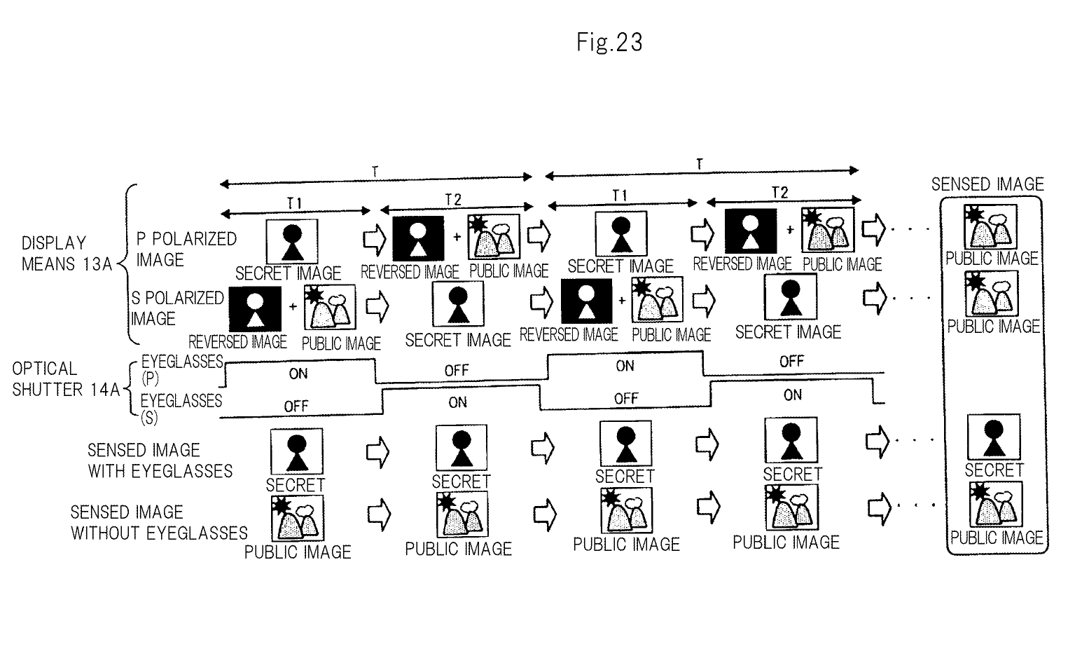

FIG. 23 is a schematic diagram that describes the theory of operation of the image display system according to this exemplary embodiment. Referring to FIG. 23, in display period T, switching is performed between first display state T1 and second display state T2.

In first display state T1, display means 13A displays the secret image (Q) with the P polarized light and a combined image of the reversed image (I) and the public image (P) with the S polarized light. Moreover, in first display state T1, optical shutter 14A transmits the P polarized component and blocks the S polarized component. In this case, of the secret image (Q) of the P polarized light and the combined image of the reversed image (I) and the public image (Q) of the S polarized light that are displayed on display means 13A, only the secret image (Q) of the P polarized light is transmitted through optical shutter 14A. Thus, in first display state T1, if optical shutter 14A is used, the secret image (Q) becomes a sensed image (a sensed image with eyeglasses shown in FIG. 23). In contrast, if optical shutter 14A is not used, since the secret image (Q) of the P polarized light and the combined image of the reversed image (I) and the public image (P) of the S polarized light that are displayed on display means 13A are observed, the secret image (Q) of the P polarized light and the reversed image (I) of the S polarized light are spatially canceled and becomes a gray image and thereby the public image (P) is sensed (a sensed image without eyeglasses shown in FIG. 23).

In second display state T2, display means 13A displays the combined image of the reversed image (I) and the public image (P) of the P polarized light and the secret image (Q) of the S polarized light. Moreover, in second display state T2, optical shutter 14A transmits the S polarized component and blocks the P polarized component. In this case, of the combined image of the reversed image (I) and the public image (P) of the P polarized light and the secret image (Q) of the S polarized light that are displayed on display means 13A, only the secret image (Q) of the S polarized light is transmitted through optical shutter 14A. Thus, in second display state T2, if optical shutter 14A is used, the secret image (Q) becomes a perspective image (a sensed image with eyeglasses shown in FIG. 18). If optical shutter 14A is not used, like the case in above-described first display state T1, the secret image (Q) of the S polarized light and the reversed image (I) of the P polarized light are spatially canceled and becomes a gray image and thereby the public image (P) is sensed (a sensed image without eyeglasses shown in FIG. 23).

In the image display system according to this exemplary embodiment, display period T needs to be a period equal to or greater than the critical fusion frequency that depends on the contrast ratio of the secret image (Q) and the combined image of the reversed image (I) and the public image (P) and the average luminance of all of both the images. Specifically, in the image display system according to this exemplary embodiment, multiplexing section 12 refers to the characteristic data (data that represents the characteristic as shown in FIG. 7) that is stored in a storage section to obtain the critical fusion frequency in an area (an area in which the difference between brightness and darkness is the largest) in which the contrast ratio between the secret image (Q) and the combined image (reversed image (I) and public image (P)) is the closest to 1. Thereafter, multiplexing section 12 generates a QIP multiplexed image such that display means 13 switches between the first and second display states on display means 13A in display period T equal to or greater than the obtained critical fusion frequency. Thus, the secret image (Q) and the combined image displayed on display means 13 are always temporally fused. Consequently, if optical shutter 14 performs switching between the first and second polarization separation state in synchronization with the first and second states, a secret image in which the secret image (Q) of the P polarized light and the secret image (Q) of the S polarized light are temporally fused is sensed. On the other hand, if a display image on display means 13A is viewed using an optical shutter that transmits either the P polarized light or the S polarized light, an image (public image) in which the secret image (Q) and the combined image are temporally fused is sensed.

In display period T, switching between first display state T1 and second display state T2 can be performed at any timing. In display period T, the first display state may be executed n times (where n is any positive integer), whereas the second display state may be executed m times (where m is any positive integer). Moreover, in display period T, switching between the first and second display states may be performed multiple times. In consideration of a decrease of flicker in the case in which an image is viewed through optical shutter 14A, in display period T, it is preferred that the total duration in which the first display state is executed be the same as the total duration in which the second display state is executed.

On the other hand, the critical fusion frequency varies depending on the magnitude of the contrast ratio of the secret image (Q) and the reversed image (I). Specifically, if the contrast ratio is large, the critical fusion frequency becomes high; if the contrast ratio is small, the critical fusion frequency becomes low. Thus, it is preferred that multiplexing section 12 change display period T depending on the magnitude of the contrast ratio between the secret image (Q) and the reversed image (I) (or the brightness of both images QI).

In the image display system according to this exemplary embodiment, the first to third exemplary structures of display means 13 according to the first exemplary embodiment may be applied to display means 13A. In addition, the exemplary structure of optical shutter 14 according to the first exemplary embodiment may be applied to optical shutter 14A.

In the image display system according to this exemplary embodiment as described above, in addition to the effect of which the problems of flickers, false contours, and forging can be solved, a public image having a stable image quality can be provided to a person who does not use the optical shutter. In addition, although three display states need to be used according to the second exemplary embodiment, according to the third exemplary embodiment, however by switching between only two display states, a public image can be provided to a person who does not use the optical shutter.

Each embodiment described above is an example of the present invention and the structure and operation thereof may be appropriately changed without departing from the scope of the present invention.

For example, in the first to third exemplary embodiments, as a display means, a structure including a ¼ wavelength plate may be used and as an optical shutter, a structure using the ¼ wavelength plate may be used.

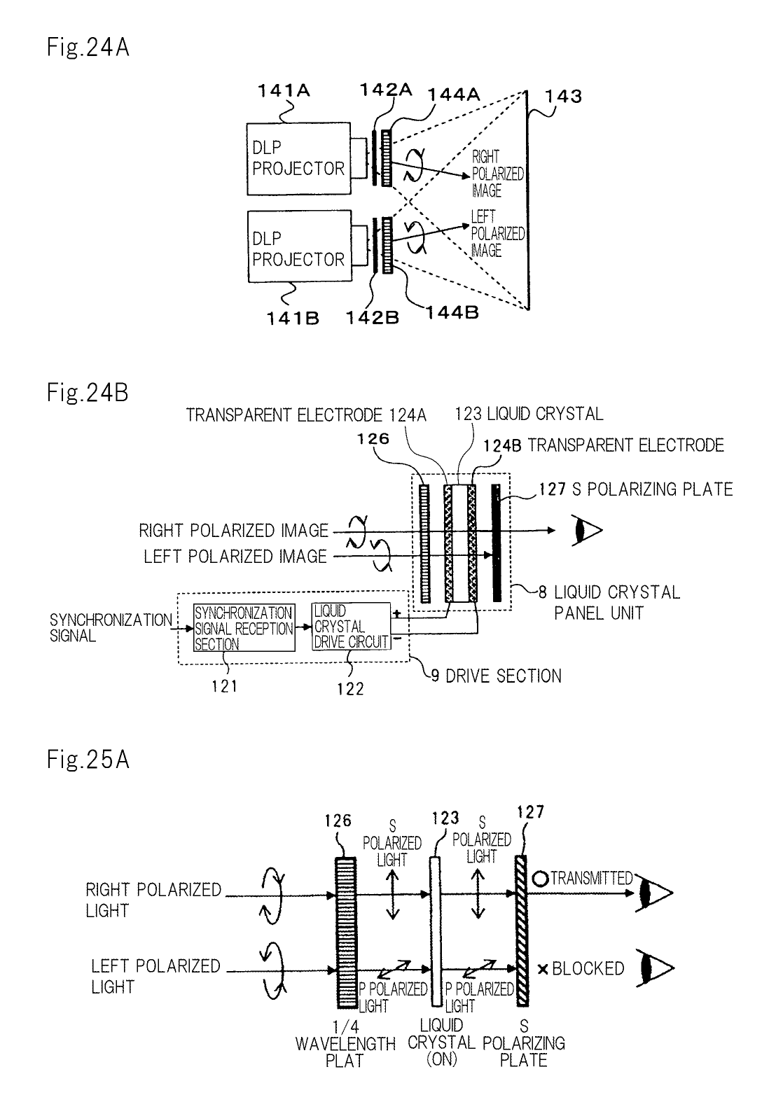

FIG. 24A is an example of the display means that uses a ¼ wavelength plate. ¼ wavelength plate 144A, 144B are arranged at an emitting section of a display means that uses DLP projectors 141A, 141B shown FIG. 8. In this structure, a P polarized image that passes through DLP projector 141A and polarizing plate 142A is converted into a right polarized image by ¼ wavelength plate 144A. On the other hand, an S polarized image that passes through DLP projector 141B and S polarizing plate 142B is converted into a left polarized image by ¼ wavelength plate 144B.

FIG. 24B is a block diagram showing the structure of an optical shutter using a ¼ wavelength plate.

An optical shutter shown in FIG. 24A is an exemplary embodiment of an optical shutter that switches between the first and second polarization separation states in synchronization with switching between the first and second display states on the display means.

The optical shutter includes liquid crystal panel unit 8 and liquid crystal drive section 9 that drives liquid crystal panel unit 8. Liquid crystal drive section 9 includes synchronization signal reception section 121 and liquid crystal drive circuit 122. Liquid crystal panel unit 8 includes liquid crystal panel 8A that sandwiches liquid crystal 123 with two transparent electrodes 124A, 124B, ¼ wavelength plate 126 arranged on an incident surface side of liquid crystal panel 8A, and S polarizing plate 127 arranged on an emitting surface side of the liquid crystal panel.

In optical shutter 14A of this exemplary structure, synchronization signal reception section 195 receives a 2-bit multiplexing synchronization signal from multiplexing section 12 and supplies a P polarized light control signal and an S polarized light control signal to liquid crystal drive circuit 122. The P polarized light control signal remains at the high level during the first display state, whereas it remains at the low level during the second display state. The S polarized light control signal remains at the high level during the second display state and it remains at the low level during the first and third display state.

While the P polarized light control signal remains at the high level, liquid crystal drive circuit 122 supplies a voltage that causes liquid crystal 123 to be turned on between transparent electrodes124A, 124B. In contrast, while the P polarized light control signal remains at the low level, liquid crystal drive circuit 122 supplies a voltage that causes liquid crystal 123 to be turned off (for example, a voltage of 0 V) between transparent electrodes 124A, 124B.

Generally, a ¼ wavelength plate is an optical device that serves to shift the phases of the vertically polarized component and the horizontally polarized component of an incident light by 90 degrees and that can mutually convert between a linearly polarized light and a circularly polarized light. In ¼ wavelength plate 126, if the incident light is a right polarized light, the transmitted light becomes an S polarized light; if the incident light is a left polarized light, the transmitted light becomes a P polarized light.

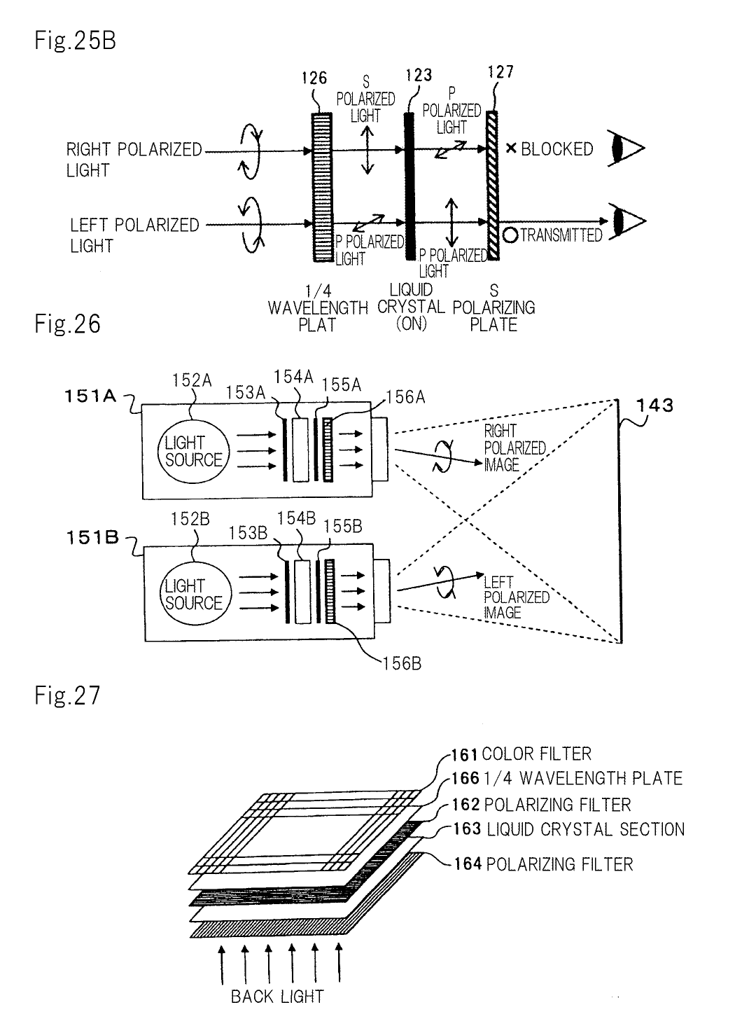

FIG. 25A and FIG. 25B are schematic diagrams describing the operation of the optical shutter shown in FIG. 24B. FIG. 25A is a schematic diagram showing a first polarization separation state, whereas FIG. 25B is a schematic diagram showing a second polarization separation state.

As shown in FIG. 25A, image lights (right polarized light and left polarized light) that pass through the display means shown in FIG. 24A enter ¼ wavelength plate 126. The image light of the left polarized light is converted into an image light of an S polarized light by ¼ wavelength plate 126. The image light of the left polarized light is converted into an image light of the P polarized light by ¼ wavelength plate 126.

The image lights (P polarized light and S polarized light) that pass through ¼ wavelength plate 126 enter liquid crystal 123. Since liquid crystal 123 remains in the on state, the entered image lights (P polarized light and S polarized light) are transmitted through liquid crystal 123, in which their polarized states are maintained. The image light of the S polarized light of image light that is transmitted through liquid crystal 123 is transmitted through S polarizing plate 127 and the image light of the P polarized light is blocked by S polarizing plate 127. As a result, the optical shutter allows the right polarized image emitted from the display means to be observed.

On the other hand, as shown in FIG. 25B, if liquid crystal 123 is in the off state, the P polarized light and S polarized light that enter liquid crystal 123 are converted into an S polarized light and an P polarized light, respectively. The image light (S polarized light) that passes through liquid crystal 123 is transmitted through S polarizing plate 127. The image light (P polarized light) that passes through liquid crystal 123 is blocked by S polarizing plate 127. As a result, the optical shutter allows a left polarized image emitted from the display means to be observed.

Since the switching timings between the first and second polarization separation states shown in FIG. 25A and FIG. 25B synchronize with the switching timings between the first and second display states on display means 13A, if a display image on display means 13A is observed through the optical shutter, only the secret image is sensed. If the optical shutter is not used, a gray image in which the secret image and reversed image are fused or in which these images and the public image are fused is sensed.

As described above, the merit in which the display means and the optical shutter are structured using a ¼ wavelength plate is in that even if the inclination of the optical shutter varies against the display means, a secret image can be accurately viewed. If the display means shown in FIG. 8 to FIG. 10 is combined with the optical shutter and so forth shown in FIG. 13 and if the optical shutter through which a secret image is displayed is rotated by 90 degrees, an S polarized image instead of a P polarized image is transmitted. Alternatively, a P polarized image instead of an S polarized image is transmitted. Thus, in this case, when a display image is viewed through the optical shutter, a reversed image instead of the secret image is viewed. If a ¼ wavelength plate is used, because of separation into a right polarized light and a left polarized light, the secret image is displayed regardless of how the optical shutter is inclined, resulting in preventing the above-described problem.

The display means using a ¼ wavelength plate is not limited to the structure shown in FIG. 24A. FIG. 26 shows another example of the display means using a ¼ wavelength plate.

The display means shown in FIG. 26 is made up the structure shown in FIG. 9 and ¼ wavelength plates 156A, 156B. ¼ wavelength plate 156A is arranged on an emitting surface side of P polarizing plate 155A in liquid crystal projector 151A. ¼ wavelength plate 156B is arranged on an emitting surface side of polarizing plate 155B in liquid crystal projector 151B. The display means structured in such a manner also allows the display operation that is the same as that of the display means shown in FIG. 24A to be performed.

FIG. 27 is a schematic diagram showing another example of the display means using a ¼ wavelength plate. This display means is made up the structure shown in FIG. 10 and ¼ wavelength plate 166. ¼ wavelength plate 166 is arranged between polarizing filter 162 and color filter161. The display means structured in such a manner also allows the display operation that is the same as that of the display means shown in FIG. 24A to be performed.

As another example of the optical shutter using a ¼ wavelength plate, in the structure shown in FIG. 19, a ¼ wavelength plate is arranged on an incident surface side of liquid crystal panel 4A.

In addition, as the structure of display means 13 or optical shutter 14, a ½ wavelength plate may be used. The ½ wavelength plate includes a function to convert an S polarized light into a P polarized light and a P polarized light into an S polarized light. In other words, a plane S polarizing filter and a plane P polarizing filter are used for polarizing filters 162, 164, respectively, shown in FIG. 10, instead of the stripe-shaped or checker-shaped polarizing filters as shown in FIG. 11B and FIG. 11C or FIG. 12A and FIG. 12B and then a checker-shaped ½ wavelength filer in which a ½ wavelength film and a transparent film are alternately layered in a stripe shape or in a checker shape outside polarizing filter 162 (on the emitting side of image light) or outside color filter161 (on the emitting side of image light) shown in FIG. 10 is added. This structure has the merit in which a display means having the same function as that shown in FIG. 10 can be realized, only by adhering the checker-shaped ½ wavelength filter to the surface of an existing liquid crystal panel. In this structure, a light transmitted through polarizing filter 162 becomes an S polarized light regardless of pixels. However, pixels that transmit the transparent film remain in an S polarized light, whereas pixels that transmit the ½ wavelength film are converted into a P polarized light.

Likewise, in FIG. 21, instead of checker-shaped polarizing filters, like polarizing filters 193, 194, a P polarizing filter and an S polarizing filter may be used for polarizing filters 193, 194, respectively, and a checker-shaped ½ wavelength filer may be added outside (on the incident side of image light) P polarizing filter 193.

Moreover, in the structure using the above-described ½ wavelength filter, a checker-shaped ¼ wavelength filter in which a ¼ wavelength plate shown in FIG. 24B, FIG. 25A, or FIG. 25B and a ¼ wavelength plate that has a reverse polarization converting function of that of one shown in FIG. 24B, FIG. 25A, or FIG. 25B (an S polarized light is converted into a right polarized light, a right polarized light into a P polarized light, a P polarized light into a left polarized light, and a left polarized light into an S) are alternatively layered in a stripe shape or a checker shape may be used instead of the checker-shaped ½ filter. This structure can accomplish the display means having a function equivalent to that shown in FIG. 24B by adding only a ¼ wavelength filter to an existing liquid crystal panel.

Each embodiment described above is an example of the present invention and the structure and operation thereof may be appropriately changed without departing from the scope of the present invention.

For example, in each embodiment, the display control means may be structured as an external image processing device other than the system. In this case, the image display system is made up a display means and an optical shutter. In addition, the image processing device can be realized for example by a personal computer.

Alternatively, the image display system may be composed of both an image display device including at least a display means and an optical shutter. In this case, the image display device may be composed either of a display control means and a display means or of a part of display control means and a display means. In this case, the part of display control means is for example a multiplexing section.

As described above, according to the present invention, since the difference of luminances between an image in which a first image (secret image) and a second image (reversed image) are spatially fused and that is displayed in the first display state and an image in which a first image (secret image) and a second image (reversed image) are spatially fused and that is displayed in the second display state is sufficiently smaller than the difference of luminances between a white image and a black image that are alternatively displayed, the occurrence of flicker can be suppressed.

In comparison with the image display devices described in Patent Literature 1 and Patent Literature 2, it is difficult to forge the structure that controls the polarization separation states of the optical shutter in synchronization with the switching timings between the first display state and the second display state on the display means. Thus, secretly glancing at display image by using a forged optical shutter or the like can be prevented.

In addition, if a moving image is displayed, a false contour that occurs on the moving image that is displayed with the first polarized light is canceled by a false contour that occurs on the moving image that is displayed with the second polarized light. Thus, since false contours sensed by a person who does not wear eyeglasses can be suppressed, the secrecy of the first image (secret image) can be improved.

Now, the present invention has been described with reference to the embodiments. However, it should be understood by those skilled in the art that the structure and operation of the present invention may be changed in various manners without departing from the scope of the present invention.

The present application claims priority based on Japanese Patent Application JP 2008-269963A filed on Oct. 20, 2008, the entire contents of which being incorporated herein by reference in its entirety.

1. An image display system, comprising:
display means that displays at least two display states at different timings, said two display states being a first display state in which a first image is displayed with a first polarized light and a second image is displayed with a second polarized light whose polarized component is different from that of said first polarized light, said second image serving to cancel said first image, and a second display state in which said second image is displayed with said first polarized light and said first image is displayed with said second polarized light; and
an optical shutter that transmits said first polarized light and blocks said second polarized light in said first display state and transmits said second polarized light and blocks said first polarized light in said second display state.

2. The image display system according to claim 1, further comprising:
display control means that controls switching between said first display state and said second display state.

3. The image display system according to claim 2,
wherein said display control means generates said second image from said first image.

4. The image display system according to claim 2,
wherein a display period of said display means is a period equal to or greater than a critical fusion frequency defined by a contrast ratio between said first and second images and an average luminance value of all of said first image and said second image, and
wherein said display control means performs switching between said first and second display states in said display period.

5. The image display system according to claim 1, further comprising:
an image conversion section that receives a first image signal including a luminance value of each pixel that makes up said first image and that performs a reverse process for the luminance value of said each pixel based on a predetermined characteristic to generate a second image signal that represents said second image; and
a multiplexing section that outputs a multiplexed signal in which said first image signal and the second image signal generated in said image conversion section are multiplexed and also outputs a synchronization signal that represents switching timings of said first and second display states,
wherein said optical shutter controls transmission and blockage of said first and second polarized lights based on said synchronization signal supplied from said multiplexing section.

6. The image display system according to claim 1,
wherein said second image includes a reversed image obtained by performing a reverse process for the luminance value of each pixel that makes up said first image based on a predetermined characteristic and a public image that is different from said first image.

7. The image display system according to claim 6, further comprising:
an image conversion section that receives a first image signal including a luminance value of each pixel that makes up said first image and that performs a reverse process for the luminance value of said each pixel based on a predetermined characteristic to generate a second image signal; and
a multiplexing section that outputs a multiplexed signal of said first image signal and the second image signal generated in said image conversion section and also outputs a synchronization signal that represents switching timings of said first and second display states,
wherein said optical shutter controls transmission and blockage of said first and second polarized lights based on said synchronization signal supplied from said multiplexing section.

8. The image display system according to claim 2,
wherein said display control means alternately switches between said first display state and said second display state.

9. The image display system according to claim 2,
wherein said display control means randomly switches between said first display state and said second display state.

10. The image display system according to claim 1,
wherein said display means is capable of switching among three display states of said first display state, said second display state, and a third display state in which a third image is displayed with said first and second polarized lights, said third image being different from said first image, and
wherein said optical shutter blocks said first and second polarized lights in said third display state.

11. The image display system according to claim 10, further comprising:
display control means that controls switching among said first to third display states,
wherein a display period of said display means is a period equal to or greater than a critical fusion frequency defined by a contrast ratio between images having a highest contrast ratio of pairs of said first and second images, said second and third images, and said first and third images and an average luminance value of all of both the images, and
wherein said display control means performs switching among said first to third second display states in said display period.

12. The image display system according to claim 10,
wherein said display control means includes:
an image conversion section that receives a first image signal including a luminance value of each pixel that makes up said first image and that performs a reverse process for the luminance value of said each pixel based on a predetermined characteristic to generate a second image signal that represents said second image; and
a multiplexing section that outputs a multiplexed signal in which said first image signal, said second image signal generated in said image conversion section, and a third image signal that includes a luminance signal of each pixel that makes up said third image are multiplexed and also outputs a synchronization signal that represents switching timings among said first to third display states, and
wherein said optical shutter controls transmission and blockage of said first and second polarized lights based on said synchronization signal supplied from said multiplexing section.

13. The image display system according to claim 10,
wherein said display control means successively switches among said first to third display states.

14. The image display system according to claim 10,
wherein said display control means randomly switches among said first to third display states.

15. An image display device, comprising:
display means that displays at least two display states at different timings, said two display states being a first display state in which a first image is displayed with a first polarized light and a second image is displayed with a second polarized light whose polarized component is different from that of said first polarized light, said second image serving to cancel said first image, and a second display state in which said second image is displayed with said first polarized light and said first image is displayed with said second polarized light; and
display control means that controls switching between said first display sate and said second display state and outputs a synchronization signal that represents switching timings between the first and second display states.

16. The image display device according to claim 15,
wherein a display period of said display means is a period equal to or greater than a critical fusion frequency defined by a contrast ratio between said first and second images and an average luminance value of all of said first and second images, and
wherein said display control means performs switching between said first and second display states in said display period.

17. The image display device according to claim 15,
where said display control means includes:
an image conversion section that receives a first image signal including a luminance value of each pixel that makes up said first image and that performs a reverse process for the luminance value of said each pixel based on a predetermined characteristic to generate a second image signal that represents said second image; and
a multiplexing section that supplies a multiplexed signal in which said first image signal and the second image signal generated in said image conversion section are multiplexed and that generates a synchronization signal that represents switching timings of said first and second display states.

18. The image display device according to claim 17,
wherein said second image includes a reversed image obtained by performing a reverse process for a luminance value of each pixel that makes up said first image based on a predetermined characteristic and a public image that is different from said first image.

19. The image display device according to claim 18,
wherein said multiplexing section multiplexes said first image signal and said second image signal to generate said multiplexed signal.

20. The image display device according to claim 15,
wherein said display control means alternately switches between said first display state and said second display state.

21. The image display device according to claim 15,
wherein said display means randomly switches between said first display state and said second display state.

22. The image display device according to claim 15,
wherein said display means is capable of switching among three display states of said first display state, said second display state, and a third display state in which a third image is displayed with said first and second polarized lights, said third image being different from said first image,
wherein said display control means includes:
an image conversion section that receives a first image signal including a luminance value of each pixel that makes up said first image and that performs a reverse process for the luminance value of said each pixel based on a predetermined characteristic to generate a second image signal; and
a multiplexing section that supplies a multiplexed signal in which said first image signal, said second image signal generated in said image conversion section, and a third image signal that includes a luminance signal of each pixel that makes up said third image are multiplexed and that generates a synchronization signal that represents switching timings among said first to third display states, and
wherein said display means displays an image with said first and second polarized lights in said first to third display states based on said multiplexed signal supplied from said multiplexing section.

23. The image display device according to claim 23,
wherein a display period of said display means is a period equal to or greater than a critical fusion frequency defined by a contrast ratio between images having a highest contrast ratio of pairs of said first and second images, said second and third images, and said first and third images and an average luminance value of all of both the images, and
wherein said display control means performs switching among said first to third second display states in said display period.

24. The image display device according to claim 22,
wherein said display control means successively switches among said first to third display states.

25. The image display device according to claim 22,
wherein said display control means randomly switches among said first to third display states.

26. An optical shutter that serves to observe a display image on an image display device that is capable of switching between two display states of a first display state in which a first image is displayed with a first polarized light and a second image is displayed with a second polarized light whose polarized component is different from that of said first polarized light, said second image serving to cancel said first image, comprising:
a liquid crystal panel unit that switches between a first polarization separation state in which said first polarized light is transmitted and said second polarized light is blocked and a second polarization separation state in which said second polarized light is transmitted and said first polarized light is blocked; and
a liquid crystal drive section that causes, based on a synchronization signal that is supplied from said image display device and that represents switching timings between said first and second display, said liquid crystal panel unit to operate in said first polarization separation state when said synchronization signal states represents said first display state, and to operate in said second polarization separation state when said synchronization signal represents said second display state.

27. The optical shutter according to claim 26,
wherein said liquid crystal panel unit includes:
a liquid crystal panel that is capable of switching between a state in which an incident light is transmitted and in which its polarized state is maintained and a state in which a polarized state of the incident light changes when it is transmitted; and
a polarizing plate arranged on an emitting surface side of said liquid crystal panel.

28. The optical shutter according to claim 27,
wherein said liquid crystal panel unit further includes a ¼ wavelength plate arranged on an incident surface side of said liquid crystal panel.

29. An optical shutter that serves to observe a display image on an image display device that is capable of switching among three display states of a first display state in which a first image is displayed with a first polarized light and a second image is displayed with a second polarized light whose polarized component is different from that of said first polarized light, said second image serving to cancel said first image, a second display state in which said second image is displayed with said first polarized light and said first image is displayed with said second polarized light, and a third display state in which a third image is displayed with said first and second polarized lights, said third image being different from said first image, comprising:
a liquid crystal panel unit that switches among a first polarization separation state in which said first polarized light is transmitted and said second polarized light is blocked, a second polarization separation state in which said second polarized light is transmitted and said first polarized light is blocked, and a third polarization separation state in which both said first and second polarized lights are blocked; and
a liquid crystal drive section that causes, based on a synchronization signal that is supplied from said image display device and that represents switching timings between said first and second display, said liquid crystal panel unit to operate in said first polarization separation state when said synchronization signal states represents said first display state, to operate in said second polarization separation state when said synchronization signal represents said second display state, and to operate in said third polarization separation state when said synchronization signal represents said third display state.

30. The optical shutter according to claim 29,
wherein said liquid crystal panel unit includes:
first and second liquid crystal panels that are capable of switching between a state in which an incident light is transmitted and in which its polarized state is maintained and a state in which a polarized state of the incident light changes when it is transmitted;
a first polarizing plate arranged on an emitting surface side of said first liquid crystal panel and on an incident surface side of said second liquid crystal panel; and
a second polarizing plate arranged on an exist side of said second liquid crystal panel.

31. The optical shutter according to claim 30,
wherein said liquid crystal panel unit further includes a ¼ wavelength plate arranged on an incident surface side of said first liquid crystal panel.
